(19) United States
(12) Patent Application Publication
(10) Pub. No.: US 2025/0056518 A1
(43) Pub. Date: Feb. 13, 2025

(54) BEAM SELECTION AND COLLISION DETECTION

(71) Applicant: QUALCOMM Incorporated, San Diego, CA (US)

(72) Inventors: Qing LI, PRINCETON JUNCTION, NJ (US); Junyi LI, Greentown, PA (US)

(21) Appl. No.: 18/792,351

(22) Filed: Aug. 1, 2024

Related U.S. Application Data
(60) Provisional application No. 63/518,040, filed on Aug. 7, 2023.

(51) Int. Cl. H04W 72/044

(52) U.S. Cl. CPC H04W 72/046

(57) ABSTRACT

Methods, systems, and devices for wireless communications are described. The techniques described herein relate to collision detection in order to reduce degradation and delay otherwise associated with initial beam pairing or beam management when a beam sweeping collision occurs in sidelink. A receiving UE receives, from a transmitting UE, one or more beam sweeping transmissions during a beam sweeping burst in a resource allocation. The receiving UE measures each reference signal of the beam sweeping burst based on receiving the one or more beam sweeping transmissions. The receiving UE transmits, to the transmitting UE, an indication of a collision between different beam sweeping transmissions during the beam sweeping burst based on the measurement satisfying a threshold.

### CROSS REFERENCE

The present Application for Patent claims the benefit of U.S. Provisional Patent Application No. 63/518,040 by LI et al., entitled “BEAM SELECTION AND COLLISION DETECTION,” filed Aug. 7, 2023, assigned to the assignee hereof, and expressly incorporated by reference herein.

### FIELD OF TECHNOLOGY

The following relates to wireless communications, including collision detection.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

Some wireless communications systems may support sidelink communications, in which multiple UEs may directly communicate with each other, for example, without using other devices in the wireless communicates systems (e.g., a network entity or a base station). Such sidelink systems may operate using millimeter wave (mmW) frequency ranges, such as frequency range 2 (FR2) frequencies, and may support beamformed sidelink transmissions. For example, the sidelink systems may support initial beam pairing, beam management, or both. In some cases, multiple transmitting UEs, such as a first UE and a second UE, may transmit beam sweeping transmissions to a receiving UE, such as a third UE, to facilitate beam pairing with the third UE. However, the transmitting UEs may transmit the beam sweeping transmissions over a same set of resources, resulting in a collision in the set of resources. The collision may cause interference in beam pairing between the first UE and the third UE or the second UE and the third UE, degrading or delaying initial beam pairing performance. Moreover, multiple transmitting UEs may select resources that partially or completely overlap when transmitting beam sweeping transmission for beam maintenance (e.g., beam fine tuning or beam measurements), also causing a collision.

### SUMMARY

The described techniques relate to improved methods, systems, devices, and apparatuses that support collision detection. A receiving UE may transmit an indication of a collision to a transmitting UE to facilitate efficient beam pairing and beam management. As part of an initial beam pairing, the receiving UE may transmit the indication of the collision when a reference signal received quality (RSRQ) or signal to interference and noise ratio (SINR) (e.g., measurement of beam quality) of transmission beams of one or more beam sweeping bursts is less than an RSRQ or SINR threshold. The threshold may be preconfigured, configured, or activated for collision detection during initial beam pairing. The collision may occur when the receiving UE receives multiple beam sweeping transmissions from multiple overlapping (in time) beam sweeping bursts associated with multiple transmitting UEs including the transmitting UE. The indication of the collision may be a negative acknowledgement (NACK). The receiving UE may transmit the indication of the collision to the transmitting UE at a beam response occasion (e.g., a time resource or allocation) associated with a selected transmission beam (e.g., the transmission beam with the greatest RSRQ, SINR, or RSRP). In some cases, the receiving UE may determine a selected best transmission beam (e.g., best transmission beam to pair with) when the RSRQ, SINR, or RSRP, of a transmission beam of multiple transmission beams associated with one or more beam sweeping bursts is the greatest or greater than an RSRQ, SINR, or RSRP threshold. The threshold may be preconfigured, configured, or activated for best beam selection during initial beam pairing. The receiving UE may transmit the indication of the selected best transmission beam for beam pairing at a beam response occasion that corresponds to the selected best transmission beam. The indication of the selected best transmission beam may be an acknowledgement (ACK). In some examples, the receiving UE may transmit the indication of the collision (e.g., NACK) to the transmitting UE at the beam response occasion associated with the selected transmission beam (e.g., with the greatest RSRQ, SINR, or RSRP).

As part of beam management after the initial beam pairing, the receiving UE may measure the RSRQ or SINR of the transmission beams of the one or more beam sweeping bursts associated with the transmitting UE. The receiving UE may transmit the indication of a collision when the RSRQ or SINR for transmission beams of one or more beam sweeping bursts is less than a RSRQ or SINR threshold that may be preconfigured, configured, or activated for collision detection during beam management after the initial beam pairing. The receiving UE may transmit the indication of the collision (e.g., NACK) with an active transmission beam corresponding to the active reception beam. The active reception beam may be paired with the transmitting UE and the transmitting UE may monitor for the indication of the collision with an active reception beam corresponding to the active transmission beam, which is paired with the receiving UE (e.g., known pair of transmission and reception beams because of initial beam pairing). Additionally, or alternatively, the receiving UE may transmit the indication of a selected best transmission beam (e.g., for transmission beam fine tuning, beam switching, beam recovery, or the like for the beam management after initial beam pairing) when the RSRQ, SINR, or RSRP, of a transmission beam of multiple transmission beams associated with one or more beam sweeping bursts is the greatest or greater than an RSRQ, SINR, or RSRP threshold. The threshold may be preconfigured, configured, or activated for best beam selection during beam management after the initial beam pairing. The receiving UE may transmit the indication of the selected best transmission beam (e.g., ACK) with an active transmission beam corresponding to the active reception beam, which is paired with the transmitting UE. The transmitting UE may monitor for the indication of the selected best transmission beam with an active reception beam corresponding to the active transmission beam, which is paired with the receiving UE (e.g., known pair of transmission and reception beams because of initial beam pairing). A beam response occasion (e.g., a time resource or allocation) may include physical resource blocks (PRBs) in frequency, where the PRBs may be allocated or dedicated to different UEs and/or services (e.g., indicated by a mapping of one or more PRBs to respective identifiers (IDs)) at the beam response occasion. In some cases, the transmitting UE may receive multiple indications of collisions from multiple UEs. The transmitting UE may identify the collisions to be from the respective UEs based on unique UE IDs or to be associated with respective services based on IDs that are associated with respective sidelink services. The transmitting UE may reselect resources for the one or more beam sweeping bursts based on the indications.

A method for wireless communications by a first UE is described. The method may include receiving, from a second UE, one or more beam sweeping transmissions during a beam sweeping burst in a resource allocation, measuring each reference signal of the beam sweeping burst based at least in part on receiving the one or more beam sweeping transmissions, and transmitting, to the second UE, an indication of a collision between different beam sweeping transmissions during the beam sweeping burst based at least in part on the measurement satisfying a threshold.

A first UE for wireless communications is described. The first UE may include one or more memories storing processor executable code, and one or more processors coupled with the one or more memories. The one or more processors may individually or collectively operable to execute the code to cause the UE to receive, from a second UE, one or more beam sweeping transmissions during a beam sweeping burst in a resource allocation, measure each reference signal of the beam sweeping burst based at least in part on receiving the one or more beam sweeping transmissions, and transmit, to the second UE, an indication of a collision between different beam sweeping transmissions during the beam sweeping burst based at least in part on the measurement satisfying a threshold.

Another first UE for wireless communications is described. The first UE may include means for receiving, from a second UE, one or more beam sweeping transmissions during a beam sweeping burst in a resource allocation, measuring each reference signal of the beam sweeping burst based at least in part on receiving the one or more beam sweeping transmissions, and transmitting, to the second UE, an indication of a collision between different beam sweeping transmissions during the beam sweeping burst based at least in part on the measurement satisfying a threshold.

A non-transitory computer-readable medium storing code for wireless communications is described. The code may include instructions executable by a processor to receive, from a second UE, one or more beam sweeping transmissions during a beam sweeping burst in a resource allocation, measure each reference signal of the beam sweeping burst based at least in part on receiving the one or more beam sweeping transmissions, and transmit, to the second UE, an indication of a collision between different beam sweeping transmissions during the beam sweeping burst based at least in part on the measurement satisfying a threshold.

Some examples of the method, UEs, and non-transitory computer-readable medium described herein may further include operations, features, means, or instructions for determining that the measurement of the beam sweeping burst is less than the threshold that is indicative of the collision, wherein transmitting the indication is based at least in part on determining that the measurement is less than the threshold.

Some examples of the method, UEs, and non-transitory computer-readable medium described herein may further include operations, features, means, or instructions for determining that the measurement of a beam sweeping transmission of the one or more beam sweeping transmissions is greater than a second threshold or a greatest measurement value that is indicative of a selected transmission beam associated with the one or more beam sweeping transmissions from the second UE, determining a beam response occasion associated with the selected transmission beam, and transmitting the indication of the collision at the beam response occasion using a transmission beam corresponding to a reception beam of the first UE that selected the selected transmission beam associated with the second UE.

In some examples of the method, UEs, and non-transitory computer-readable medium described herein, the indication is a NACK associated with the beam sweeping burst.

Some examples of the method, UEs, and non-transitory computer-readable medium described herein may further include operations, features, means, or instructions for measuring a RSRP of a descrambled beam signal of each of the one or more beam sweeping transmissions, and measuring a RSSI of each of the one or more beam sweeping transmissions, wherein measuring the measurement of each of the one or more beam sweeping transmissions is based at least in part on the RSRP and the RSSI.

In some examples of the method, UEs, and non-transitory computer-readable medium described herein, the operations, features, means, or instructions for measuring the RSRP of the descrambled beam signal of each of the one or more beam sweeping transmissions, the one or more processors may further include operations, features, means, or instructions for determining a scrambling sequence associated with a service type identifier, an application identifier, a UE identifier associated with the second UE, or any combination thereof, and performing a descrambling of each of the one or more beam sweeping transmissions based at least in part on the scrambling sequence.

In some examples of the method, UEs, and non-transitory computer-readable medium described herein, the service type identifier, the application identifier, the UE identifier, or any combination thereof, is related to the resource allocation associated with reception of the one or more beam sweeping transmissions during the beam sweeping burst.

In some examples of the method, UEs, and non-transitory computer-readable medium described herein, the indication includes a single bit representing an acknowledgement or a negative acknowledgement associated with the beam sweeping burst.

Some examples of the method, UEs, and non-transitory computer-readable medium described herein may further include operations, features, means, or instructions for transmitting the indication of the collision at a beam response occasion associated with an active transmission beam of the second UE using a transmission beam corresponding to a reception beam that is paired with the active transmission beam.

Some examples of the method, UEs, and non-transitory computer-readable medium described herein may further include operations, features, means, or instructions for identifying that a PRB of the beam response occasion is mapped to an identifier associated with the second UE, and transmitting the indication of the collision at the PRB of the beam response occasion.

In some examples of the method, UEs, and non-transitory computer-readable medium described herein, the identifier is based at least in part on a UE identifier, a service type identifier, an application identifier, or any combination thereof.

A method for wireless communications by a first UE is described. The method may include transmitting, to a second UE, one or more beam sweeping transmissions as a beam sweeping burst in a resource, monitoring for an indication of a collision, receiving the indication of the collision over a reception beam corresponding to a transmission beam associated with the beam sweeping burst; and reselecting the resource based at least in part on the indication of the collision.

A first UE for wireless communications is described. The first UE may include one or more memories storing processor executable code, and one or more processors coupled with the one or more memories. The one or more processors may individually or collectively operable to execute the code to cause the UE to transmit, to a second UE, one or more beam sweeping transmissions as a beam sweeping burst in a resource, monitor for an indication of a collision, receive the indication of the collision over a reception beam corresponding to a transmission beam associated with the beam sweeping burst; and reselect the resource based at least in part on the indication of the collision.

Another first UE for wireless communications is described. The first UE may include means for transmitting, to a second UE, one or more beam sweeping transmissions as a beam sweeping burst in a resource, monitoring for an indication of a collision, receiving the indication of the collision over a reception beam corresponding to a transmission beam associated with the beam sweeping burst; and reselecting the resource based at least in part on the indication of the collision.

A non-transitory computer-readable medium storing code for wireless communications is described. The code may include instructions executable by a processor to transmit, to a second UE, one or more beam sweeping transmissions as a beam sweeping burst in a resource, monitor for an indication of a collision, receive the indication of the collision over a reception beam corresponding to a transmission beam associated with the beam sweeping burst; and reselect the resource based at least in part on the indication of the collision.

Some examples of the method, UEs, and non-transitory computer-readable medium described herein may further include operations, features, means, or instructions for transmitting the one or more beam sweeping transmissions using a UE identifier that is indicative of a sidelink service.

Some examples of the method, UEs, and non-transitory computer-readable medium described herein may further include operations, features, means, or instructions for receiving the indication of the collision using a reception beam that is known based at least in part on an active beam response occasion associated with the first UE and the second UE, the reception beam corresponding to a transmission beam of the active beam response occasion.

Some examples of the method, UEs, and non-transitory computer-readable medium described herein may further include operations, features, means, or instructions for receiving the indication of the collision from the second UE and a third UE using the reception beam, identifying the indication of the collision from the second UE and the indication of the collision from the third UE based at least in part on a second identifier and a third identifier, the second identifier and the third identifier indicative of respective UEs, respective sidelink services, respective sidelink applications, or any combination thereof, and reselecting the resource for transmitting the one or more beam sweeping transmissions based at least in part on the indication of the collision, the second identifier, and the third identifier.

In some examples of the method, UEs, and non-transitory computer-readable medium described herein, the resource is associated with a sidelink service, a sidelink application, or a combination thereof, associated with the first UE.

In some examples of the method, UEs, and non-transitory computer-readable medium described herein, the resource is a frequency resource, a time resource, or a combination thereof.

Some examples of the method, UEs, and non-transitory computer-readable medium described herein may further include operations, features, means, or instructions for receiving the indication of the collision over the reception beam from a third UE, and identifying the indication of the collision to be from the second UE and from the third UE based at least in part on respective services associated with the second UE and the third UE.

In some examples of the method, UEs, and non-transitory computer-readable medium described herein, transmitting the one or more beam sweeping transmissions is based at least in part on a capability message, a sidelink information message, or a combination thereof.

### BRIEF DESCRIPTION OF THE DRAWINGS

FIG. 1 shows an example of a wireless communications system that supports collision detection in accordance with one or more aspects of the present disclosure.

FIG. 2 shows an example of a wireless communications system that supports collision detection in accordance with one or more aspects of the present disclosure.

FIG. 3 shows an example of an initial beam pairing procedure that supports collision detection in accordance with one or more aspects of the present disclosure.

FIG. 4 shows an example of resource allocations for different beam burst collision indications during the initial beam pairing that support collision detection in accordance with one or more aspects of the present disclosure.

FIG. 5 shows an example of a process flow that supports collision detection in accordance with one or more aspects of the present disclosure.

FIG. 6 shows an example of a beam management procedure that supports collision detection in accordance with one or more aspects of the present disclosure.

FIG. 7 shows an example of resource allocations for different beam burst collision indications during the beam management that support collision detection in accordance with one or more aspects of the present disclosure.

FIG. 8 shows an example of a process flow that supports collision detection in accordance with one or more aspects of the present disclosure.

FIG. 9 shows an example of a process flow that supports collision detection in accordance with one or more aspects of the present disclosure.

FIG. 10 shows an example of a process flow that supports collision detection in accordance with one or more aspects of the present disclosure.

FIGS. 11 and 12 show block diagrams of devices that support collision detection in accordance with one or more aspects of the present disclosure.

FIG. 13 shows a block diagram of a communications manager that supports collision detection in accordance with one or more aspects of the present disclosure.

FIG. 14 shows a diagram of a system including a device that supports collision detection in accordance with one or more aspects of the present disclosure.

FIGS. 15 through 19 show flowcharts illustrating methods that support collision detection in accordance with one or more aspects of the present disclosure.

### DETAILED DESCRIPTION

Some wireless communications systems may support sidelink communications, in which multiple user equipments (UEs) may directly communicate with each other, for example, without using other devices in the wireless communicates systems (e.g., a network entity or a base station). Such sidelink systems may operate using millimeter wave (mmW) frequency ranges, such as frequency range 2 (FR2) frequencies, and may support beamformed sidelink transmissions. For example, the sidelink systems may support initial beam pairing, beam management, or both. In some cases, multiple transmitting UEs, such as a first UE and a second UE, may transmit beam sweeping transmissions to a receiving UE, such as a third UE, to facilitate beam pairing or beam management with the third UE. However, the transmitting UEs may transmit the beam sweeping transmissions over a same set of resources, resulting in a collision in the set of resources of the beam sweeping transmissions. The collision may cause interference in beam pairing and/or beam maintenance between the first UE and the third UE or the second UE and the third UE, degrading or delaying performance. Moreover, multiple transmitting UEs may select resources that partially or completely overlap when transmitting beam sweeping transmission for beam maintenance (e.g., beam fine tuning or beam measurements), also causing a collision.

A receiving UE may detect a collision on transmission beams using a reception beam associated with the receiving UE, as well as transmit an indication of the collision to a transmitting UE to facilitate efficient beam pairing and beam management. As part of an initial beam pairing, the receiving UE may transmit the indication of the collision when a reference signal received quality (RSRQ) or signal to interference and noise ratio (SINR) (e.g., measurement of beam quality) of transmission beams of one or more beam sweeping bursts is less than an RSRQ or SINR threshold. The threshold may be preconfigured, configured, or activated for collision detection during initial beam pairing. The collision may occur when the receiving UE receives multiple beam sweeping transmissions from multiple overlapping (in time) beam sweeping bursts associated with multiple transmitting UEs including the transmitting UE. The indication of the collision may be a negative acknowledgement (NACK). The receiving UE may transmit the indication of the collision to the transmitting UE at a beam response occasion (e.g., a time resource or allocation) associated with a selected transmission beam (e.g., the transmission beam with the greatest RSRQ, SINR, or RSRP). In some cases, the receiving UE may determine a selected best transmission beam (e.g., best transmission beam to pair with) when the RSRQ, SINR, or RSRP, of a transmission beam of multiple transmission beams in the one or more beam sweeping bursts is greatest or greater than an RSRQ, SINR, or RSRP threshold. The threshold may be preconfigured, configured, or activated for best beam selection during initial beam pairing. The receiving UE may transmit the indication of the selected best transmission beam for beam pairing at a beam response occasion that corresponds to the selected best transmission beam. The indication of the selected best beam may be an acknowledgement (ACK). In some examples, the receiving UE may transmit the indication of the collision (e.g., NACK) to the transmitting UE at the beam response occasion associated with the selected transmission beam (e.g., with the greatest RSRQ, SINR, or RSRP).

As part of beam management after the initial beam pairing, the receiving UE may measure the RSRQ or SINR of the transmission beams of the one or more beam sweeping bursts associated with the transmitting UE. The receiving UE may transmit the indication of a collision when the RSRQ or SINR for transmission beams of the one or more beam sweeping bursts is less than a RSRQ or SINR threshold that may be preconfigured, configured, or activated for collision detection during beam management after the initial beam pairing. The receiving UE may transmit the indication of the collision (e.g., NACK) with an active transmission beam corresponding to the active reception beam. The active reception beam is paired with the transmitting UE and the transmitting UE may monitor for the indication of the collision with an active reception beam corresponding to the active transmission beam, which is paired with the receiving UE (e.g., known pair of transmission and reception beams because of initial beam pairing). Additionally, or alternatively, the receiving UE may transmit the indication of a selected best transmission beam (e.g., for transmission beam fine tuning, beam switching, beam recovery, or the like for the beam management after initial beam pairing) when the RSRQ, SINR, or RSRP, of a transmission beam of multiple transmission beams associated with one or more beam sweeping bursts is the greatest or greater than an RSRQ, SINR, or RSRP threshold. The threshold may be preconfigured, configured, or activated for best beam selection during beam management after the initial beam pairing. The receiving UE may transmit the indication of the selected best transmission beam (e.g., ACK) with an active transmission beam corresponding to the active reception beam, which is paired with the transmitting UE. The transmitting UE may monitor for the indication of the selected best transmission beam with an active reception beam corresponding to the active transmission beam, which is paired with the receiving UE (e.g., known pair of transmission and reception beams because of initial beam pairing). A beam response occasion (e.g., a time resource or allocation) may include physical resource blocks (PRBs) in frequency, where the PRBs may be allocated or dedicated to different UEs and/or services (e.g., indicated by a mapping of one or more PRBs to respective identifiers (IDs)) at the beam response occasion. In some cases, the transmitting UE may receive multiple indications of collisions from multiple UEs. The transmitting UE may identify the collisions to be from the respective UEs based on unique UE IDs or to be associated with respective services based on IDs that are associated with respective sidelink services. The transmitting UE may reselect resources for the one or more beam sweeping bursts based on the indications. Aspects of the disclosure are initially described in the context of wireless communications systems. Aspects of the disclosure are further illustrated by and described with reference to apparatus diagrams, system diagrams, and flowcharts that relate to collision detection.

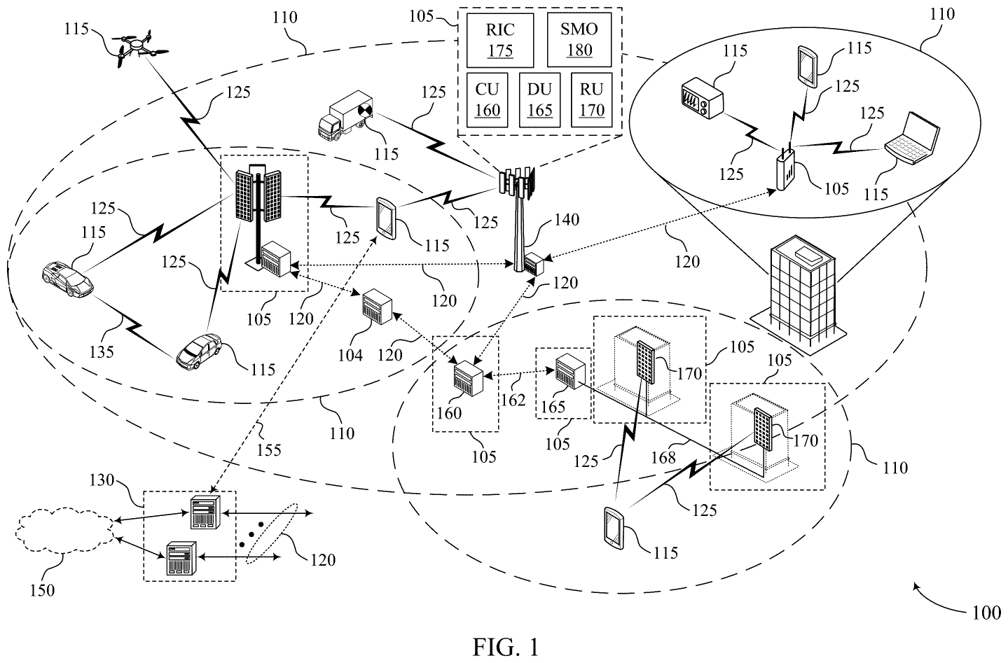

FIG. 1 shows an example of a wireless communications system 100 that supports collision detection in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support collision detection as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, Cus 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ−N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction (e.g., beam pairing link) for later transmission (e.g., using the selected or paired transmission beam) or reception (e.g., using the selected or paired reception beam) by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality (e.g., selected best transmission beam from the network entity 105).

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some wireless communications systems 100, the UEs 115 may communicate with other UEs 115 via sidelink (e.g., 5G sidelink, FR2 sidelink, sidelink unicast communication in FR2 spectrum, and so forth). The wireless communications system 100 may support sidelink beam management, such as beam pairing, beam maintenance, and beam failure recovery by using sidelink CSI framework or a Uu (e.g., air interface) beam management features.

In some cases, a sidelink synchronization signal block (S-SSB) may be used. For example, a sidelink synchronization procedure may define a hierarchy of priorities associated with different synchronization references where the UEs 115 continuously search the hierarchy to find the relatively highest quality synchronization reference of the synchronization references. However, if a UE 115 is unable to find any other synchronization reference (such as Global Navigation Satellite System (GNSS) or eNB/gNB) directly or indirectly (e.g., relayed via another UE 115), the UE 115 may use an internal clock that is internal to the UE 115 in order to transmit the S-SSB. For example, one or more S-SSBs may be transmitted via the UE 115 based on a numerology in a time period (e.g., a period of 160 milliseconds (ms)).

In some cases, sidelink control information (SCI) may be used. A first-stage SCI (e.g., a 2-symbol SCI in 1 slot) on a physical sidelink shared channel (PSCCH) transmitted by a transmitting UE 115 may indicate a time-frequency resources reserved for future transmissions with PSSCH. The SCI transmissions may be used by monitoring UEs 115 to maintain a record of which resources have already been reserved by other UEs 115. For semi-persistent scheduling (SPS), a field of Resource Reservation Period (RRP) may indicate a time interval for future periodic transmissions. For a sidelink communication adaptation and rank adaptation in unicast transmissions, a transmitting UE 115 may transmit a sidelink CSI-RS multiplexed with a physical sidelink shared channel (PSSCH) transmission and may also indicate (via a second-stage SCI (SCI 2)) aperiodic sidelink CSI reporting from the receiving UE 115 (via MAC control element (MAC-CE)). The transmitting UE may wait to trigger a subsequent CSI report from a particular receiving UE 115 until the preceding report has been received or a respective latency bound has expired. That is, the control information of the SCI (indicating resources reserved for scheduling future transmissions) is bundled together with initial transmissions carried on the PSCCH. As such, the SCI bundled with transmission data may use an entire slot. Accordingly, sweeping CSI-RS may involve sweeping the entire slot, increasing processing costs and time.

In some cases, to reduce processing costs and time otherwise associated with sweeping CSI-RS or SCI for sidelink communications, a standalone reference signal (RS) for initial beam pairing may be used. For example, a standalone RS initial beam pairing may involve a configured sidelink resource pool (e.g., dedicated sidelink or preconfigured sidelink) for the RS. The standalone RS initial beam pairing may involve time and/or frequency resource candidates and scrambling IDs for the RS for initial beam pairing that are based on a destination ID for a subsequent unicast-link establishment procedure. The standalone RS initial beam pairing may involve a resource coordination for RS for initial beam pairing among transmitting UEs 115. The RS for initial beam pairing may allow other transmitting UEs 115 to check whether the resource is available in blind manner.

In some cases, a periodic beam pairing RS may be scrambled with an m-bit scramble ID which may be derived from an M-bit layer 2 (L2) destination ID (e.g., m≤M=24), and swept in one of N sets of resources, where N sets of resources are mapped with the M-bit L2 destination ID (e.g., N=10 and M=24). In the case where N<M, different periodic beam pairing signals for different destinations or services (e.g., identified by L2 destination ID) may be transmitted over a same set of resources, causing interference among the different periodic beam pairing signals. For example, interference may occur across one or more beam pairing sweeping bursts involving transmissions over the same set of resources. The interference may degrade initial beam pairing performance and thus, cause further delays for initial beam pairing. After initial beam pairing, a transmitting UE 115 may select resources from the preconfigured or configured resources and sweep some transmit beams for beam maintenance (e.g., beam fine tuning or beam measurements). With standalone beam RS for beam maintenance, multiple transmitting UEs 115 may select resources that are completely or partially overlapping for sweeping beams, resulting in a beam sweeping collision. The collision during beam maintenance may also cause degradation, as discussed herein.

As another example, multiple transmitting UEs 115 in a wireless communications system 100 (e.g., a sidelink system), such as a first UE 115 and a second UE 115, may transmit beam sweeping transmissions to a receiving UE 115, such as a third UE 115, to facilitate beam pairing with the third UE 115. However, the transmitting UEs 115 may transmit the beam sweeping transmissions over a same set of resources, resulting in a collision in the set of resources. The collision may cause interference in beam pairing between the first UE 115 and the third UE 115 or the second UE 115 and the third UE 115, degrading or delaying initial beam pairing performance. Moreover, multiple transmitting UEs 115 may select resources that partially or completely overlap when transmitting beam sweeping transmission for beam maintenance (e.g., beam fine tuning or beam measurements), also causing a collision.

As described herein, to reduce degraded or delayed beam pairing and beam management, a receiving UE 115 may transmit an indication of a collision to a transmitting UE 115 to facilitate efficient beam pairing and beam management. As described herein, the terms “selected transmission beam” or a “best transmission beam” may refer to a transmission beam of multiple transmission beams that has either the greatest signal quality among the multiple transmission beams, a signal quality above a signal quality threshold, or both. The transmission beam of the multiple transmission beams may be associated with one or more beam sweeping bursts associated with one or more transmitting UEs 115.

In some examples, the signal quality may be measured by RSRQ, SINR, RSRP, or the like. The selected transmission beam or best transmission beam may also be indicative of a transmission beam that is best relative to other transmission beams associated with a spatial direction for receiving an indication from the receiving UE 115 by the one or more transmitting UEs 115. For example, the receiving UE 115 may measure the signal quality (e.g., based on RSRQ, SINR, or RSRP) of each transmission beam in one or more beam sweeping bursts using a reception beam. The transmission beam having the greatest signal quality or signal quality above a signal quality threshold for beam selection, may be the best transmission beam selected by the receiving UE. The receiving UE 115 may transmit an indication of the selected best transmission beam to the respective transmitting UE 115 (e.g., for beam pairing, transmitting beam fine tuning, beam switching, beam recovery, or the like with the transmitting UE 115), via the transmission beam corresponding to the reception beam used for the measurements and best transmission beam selection.

As part of an initial beam pairing, the receiving UE 115 may transmit the indication of the collision when an RSRQ or SINR (e.g., measurement of beam quality) of transmission beams of one or more beam sweeping bursts is less than an RSRQ or SINR threshold. The threshold may be preconfigured, configured, or activated for collision detection during initial beam pairing. The collision may occur when the receiving UE 115 receives multiple beam sweeping transmissions from multiple overlapping (in time) beam sweeping bursts associated with multiple transmitting UEs 115 including the transmitting UE 115). The indication of the collision may be a NACK. The receiving UE 115 may transmit the indication of the collision to the transmitting UE 115 at a beam response occasion (e.g., a time resource or allocation) associated with a selected transmission beam (e.g., the transmission beam with the greatest RSRQ, SINR, or RSRP). In some cases, the receiving UE 115 may determine a selected best transmission beam (e.g., best transmission beam to pair with) when the RSRQ, SINR, or RSRP, of a transmission beam of multiple transmission beams in the one or more beam sweeping bursts is the greatest or greater than an RSRQ, SINR, or RSRP threshold. The threshold may be preconfigured, configured, or activated for best beam selection during initial beam pairing. The receiving UE 115 may transmit the indication of the selected best transmission beam for beam pairing at a beam response occasion that corresponds to the selected best transmission beam. The indication of the selected best transmission beam may be an ACK. In some examples, the receiving UE 115 may transmit the indication of the collision (e.g., NACK) to the transmitting UE 115 at the beam response occasion associated with the selected transmission beam (e.g., with the greatest RSRQ, SINR, or RSRP).

As part of beam management after the initial beam pairing, the receiving UE 115 may measure the RSRQ or SINR of the transmission beams of the one or more beam sweeping bursts associated with the transmitting UE 115. The receiving UE 115 may transmit the indication of a collision when the RSRQ or SINR for transmission beams of one or more beam sweeping bursts is less than a RSRQ or SINR threshold. The threshold may be preconfigured, configured, or activated for collision detection during beam management after the initial beam pairing. The receiving UE 115 may transmit the indication of collision (e.g., NACK) with an active transmission beam corresponding to the active reception beam. The active reception beam is paired with the transmitting UE 115 and the transmitting UE 115 may monitor for the indication of the collision with an active reception beam corresponding to the active transmission beam, which is paired with the receiving UE 115 (e.g., known pair of transmission and reception beams because of initial beam pairing). Additionally, or alternatively, the receiving UE 115 may transmit the indication of a selected best transmission beam (e.g., for transmission beam fine tuning, beam switching, beam recovery, or the like for the beam management after initial beam pairing) when the RSRQ, SINR, or RSRP, of a transmission beam of multiple transmission beams associated with one or more beam sweeping bursts is the greatest or greater than an RSRQ, SINR, or RSRP threshold. The threshold may be preconfigured, configured, or activated for best beam selection during beam management after the initial beam pairing. The receiving UE 115 may transmit the indication of the selected best transmission beam (e.g., ACK) with an active transmission beam corresponding to the active reception beam, which is paired with the transmitting UE 115. The transmitting UE 115 may monitor for the indication of the selected best transmission beam with an active reception beam corresponding to the active transmission beam, which is paired with the receiving UE (e.g., known pair of transmission and reception beams because of initial beam pairing). A beam response occasion (e.g., frequency resource) may include PRBs, where the PRBs may be allocated or dedicated to different UEs 115 and/or services (e.g., indicated by a mapping of one or more PRBs to respective IDs) at the beam response occasion. In some cases, the transmitting UE 115 may receive multiple indications of collisions from multiple UEs 115. The transmitting UE 115 may identify the collisions to be from the respective UEs 115 based on unique UE IDs or to be associated with respective services based on IDs that are associated with respective sidelink services. The transmitting UE 115 may reselect resources for the one or more beam sweeping bursts based on the indications.

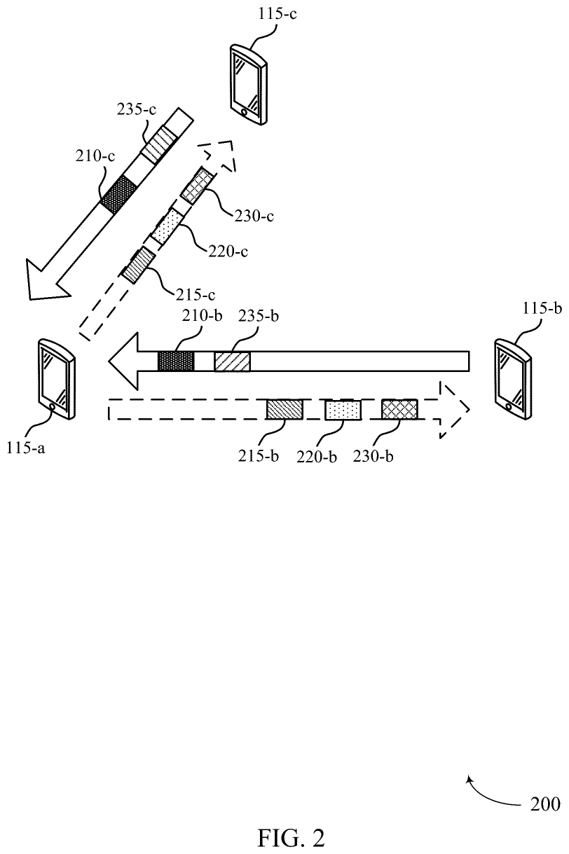

FIG. 2 shows an example of a wireless communications system 200 that supports collision detection in accordance with one or more aspects of the present disclosure. The wireless communications system 200 may implement aspects of or may be implemented by aspects of the wireless communications system 100. For example, the wireless communications system 200 includes a UE 115-a, a UE 115-b, and a UE 115-c, which may be examples of a UE 115 described with respect to FIG. 1.

The UE 115-a may be a receiving UE-a and the UE 115-b and UE 115-c may be transmitting UEs 115. Accordingly, for an initial beam pairing for sidelink communications between the UE 115-a and the UE 115-b, as well as the UE 115-a and the UE 115-c, the transmitting UEs 115-b and UE 115-c may transmit one or more beam sweeping transmissions 210-b and 210-c in a respective beam sweeping burst. The receiving UE 115-a may monitor for the one or more beam sweeping transmissions 210 for initial beam pairing. However, the one or more beam sweeping transmissions 210 from the transmitting UE 115-b and the transmitting UE 115-c may overlap, such that they are transmitted in the same resource at the same time to the receiving UE 115-a. For example, the receiving UE 115-a may receive one or more beam transmissions at a beam transmission occasion (e.g., time resource or allocation), at which the overlapping beam sweeping transmissions occur.

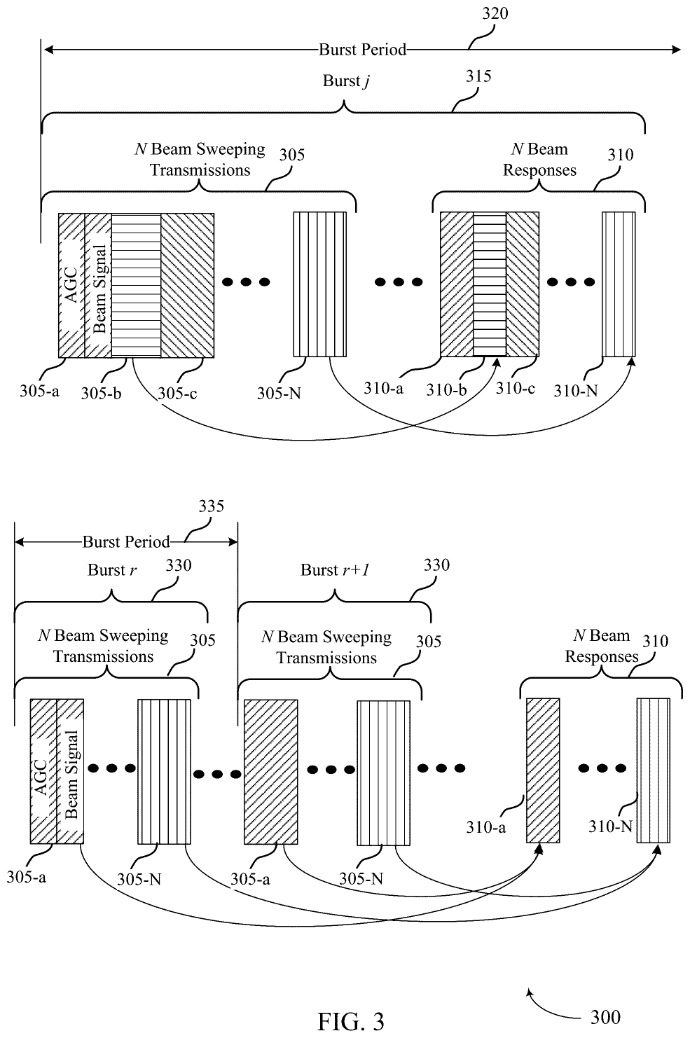

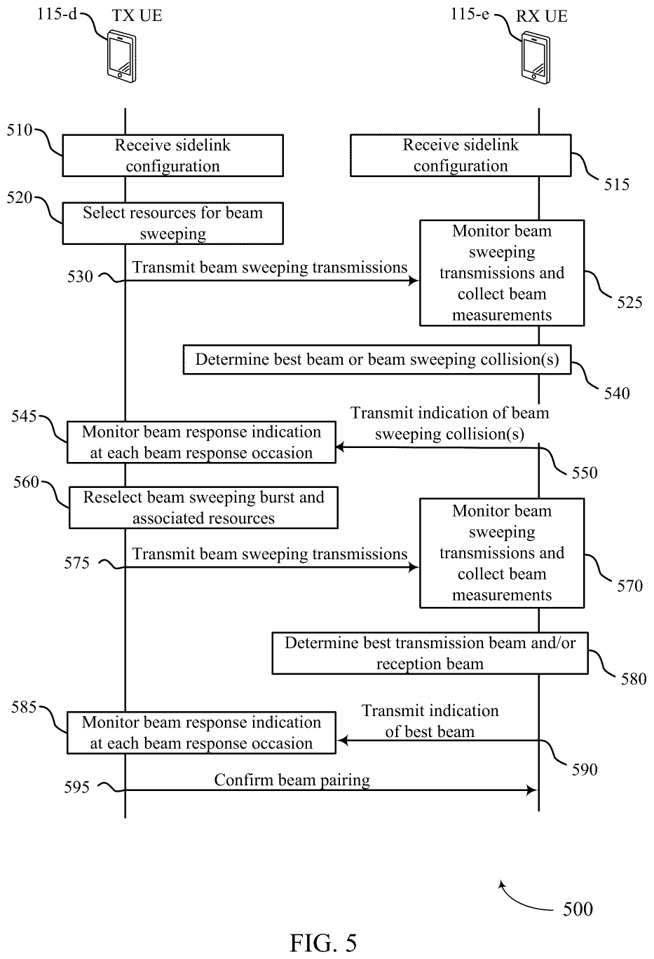

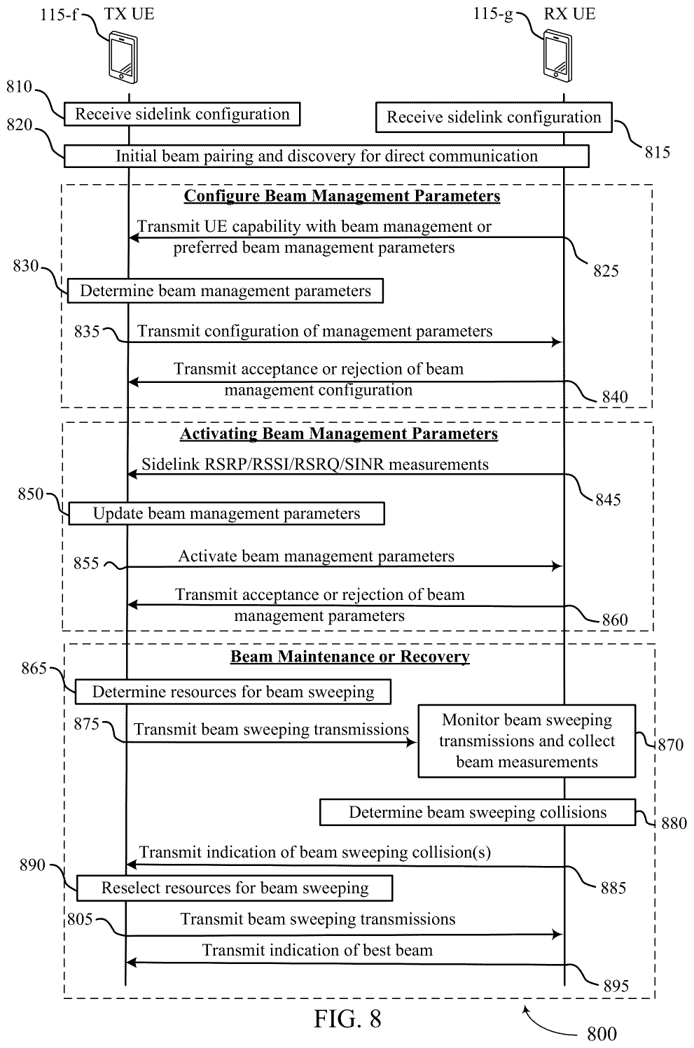

As is discussed with respect to FIGS. 3-8, the receiving UE 115-a may determine that there is a collision of transmission beams respectively from the transmitting UE 115-b and the transmitting UE 115-c at a beam transmission occasion (e.g., based on a RSRQ or SINR of the transmission beam being below an RSRQ or SINR threshold), by which the receiving UE 115-a determined the collision. The receiving UE 115-a may determine a collision between beam sweeping bursts from different transmitting UEs 115 based on an averaged RSRQ or SINR of beam transmissions or a maximum RSRQ or SINR of beam transmissions of one or more beam sweeping bursts being below an RSRQ or SINR threshold. Accordingly, the receiving UE 115-a may transmit an indication of the collision 215-b and/or 215-c to the transmitting UE 115-b and/or transmitting UE 115-c. As is discussed with respect to FIG. 5 and FIG. 8, the receiving UE 115-a may select a best transmission beam (e.g., a best transmission beam to pair with during initial beam pairing or beam recovery, or a best transmission beam for transmission beam fine tuning, beam switching, beam recovery, or the like during beam management after initial beam pairing) of the transmitting UE115-b or the transmitting UE 115-c. The selected best transmission beam is indicative of a transmission beam that is best relative to other beams associated to a spatial direction for receiving an indication from the receiving UE 115-a by the transmitting UE115-b or the transmitting UE 115-c. For example, the receiving UE 115-a may measure the RSRQ, SINR, or RSRP of each transmission beam in one or more beam sweeping bursts with a reception beam and the transmission beam. The transmission beam having the greatest RSRQ, SINR, or RSRP and/or having an RSRQ, SNIR, or RSRP above a threshold for beam selection, may be the best transmission beam selected by the receiving UE 115-a. The receiving UE 115-a may transmit an indication of the selected best transmission beam 220-b to the transmitting UE 115-b (e.g., for beam pairing, transmitting beam fine tuning, beam switching, beam recovery, or the like with the transmitting UE 115-b) and/or the selected best transmission beam 220-c to the transmitting UE 115-c (e.g., for beam pairing, transmitting beam fine tuning, beam switching, beam recovery, or the like with the transmitting UE 115-c), such as via the transmission beam corresponding to (e.g., based on beam correspondence between transmitting beam and receiving beam at a UE) the receiving beam used for the measurements and best transmission beam selection. In some examples, the receiving UE 115-a may transmit the indication of the collision 215-b to the transmitting UE 115-b at the beam response occasion associated with a selected transmission beam of the transmitting UE 115-b or the indication of the collision 215-c to the transmitting UE 115-c at the beam response occasion associated with a selected transmission beam of the transmitting UE 115-c. Transmitting at the beam response occasion associated with the selected transmission beam may be based on the selected transmission beam having the greatest RSRQ or SINR or RSRP among the other transmission beams of the transmitting UE 115-b or the transmitting UE 115-c, respectively.

In some examples, the receiving UE 115-a may transmit an indication of a UE capability 230-b (e.g., UE capability message) to the transmitting UE 115-b and an indication of a UE capability to 230-c to the transmitting UE 115-c that includes beam management parameters, or an indication of sidelink UE information (e.g., sidelink UE information message) or sidelink UE assistance information (e.g., sidelink UE assistance information message) 230-b to the transmitting UE 115-b and an indication of sidelink UE information (e.g., sidelink UE information message) or sidelink UE assistance information (e.g., sidelink UE assistance information message) 230-c to the transmitting UE 115-c including preferred beam management parameters. The beam management parameters with UE capability may include a quantity of panels, quantity of total beams or beams per panel, types of beams (e.g., narrow or wide), beam switching time, beam detecting or selecting capability, collision detection capability (e.g., supporting or not supporting), and so forth. The preferred beam management parameters with UE information or UE assistance information may include beam sweeping and report resources, beam sweeping patterns or period, conditions for triggering beam sweeping, and so forth. In some examples, the indication of sidelink UE information or sidelink UE assistance information 230 may include UE preferred parameters for best beam selection and indication or collision detection and indication (e.g., thresholds for beam selection or collision detection, resources to use for a best beam indication or a collision indication).

The transmitting UEs 115-b and 115-c may determine beam management parameters, best beam selection and indication parameters, or collision detection and indication parameters based on the received UE capability message, sidelink UE information, or sidelink UE assistance information. Based on the determination, the transmitting UE 115-b may transmit a configuration 235-b and the transmitting UE 115-c may transmit a configuration 235-c, to the receiving UE 115-a. The configuration 235 may include resources for beam sweeping bursts and associated beam responses for different beam managements (e.g., initial beam pairing, transmission or reception beam fine tuning, beam switching, beam recovery, or the like), conditions or thresholds for best beam selection and resources for best beam indication or conditions, or thresholds for beam sweeping burst collision detection and resources for beam sweeping burst collision indication. In some examples, the receiving UE 115-a may indicate to the transmitting UEs 115-b and 115-c if the configuration is accepted or rejected by the receiving UE 115-a.

FIG. 3 shows an example of an initial beam pairing procedure 300 that supports collision detection in accordance with one or more aspects of the present disclosure. The initial beam pairing procedure 300 may include N beam sweeping transmissions 305, where N is greater than 1. Each beam sweeping transmission or beam transmission contains at least an automatic gain control (AGC) symbol or a beam signal, where the AGC symbol may include the same signal or a signal that is similar to the beam signal. The beam signal may include m-sequence or sequences (e.g., primary synchronization signal (PSS) or the like, or a secondary synchronization signal (SSS) or the like) that are generated based on an ID of a beam sweeping burst (referred to as a scramble ID for the beam sweeping burst) for a sidelink service, a sidelink communication, a transmitting or receiving UE. In some examples, the sequences may be based on an ID or an index of a beam signal of a beam sweeping burst or based on an indication of TCI state of a beam signal of a beam sweeping burst. The beam signal may contain a pseudo-random sequence (e.g., CSI-RS or the like signal) initiated with an ID of a beam sweeping burst (refer to as a scramble ID for the beam sweeping burst) for a sidelink service, a sidelink communication, a transmitting or receiving UE, or based on an ID or index of a beam signal of a beam sweeping burst or an indication of TCI state of a beam signal of a beam sweeping burst. For example, the N beam sweeping transmissions 305 may include beam sweeping transmissions 305-a, 305-b, 305-c, and up to 305-N. A transmitting UE 115 may transmit the beam sweeping transmissions 305 in a beam sweeping burst 315 (e.g., such burst j including Nbeam responses 310) or a beam sweeping burst 330 (e.g., such as bursts r or r+1 without N beam responses 310), and one or more beam sweeping bursts 315 (e.g., j, k, l, and so forth) or beam sweeping bursts 330 (e.g., r, s, t, and so forth), may occur during a burst period 320 or a burst period 335, respectively. A receiving UE 115 may receive the beam sweeping transmission 305 and determine N beam responses 310, where N is greater than 1. In some examples, the N beam responses 310 may correspond to the N beam sweeping transmissions 305 within a beam sweeping burst 315. In some examples, the Nbeam responses 310 may correspond to N beam sweeping transmissions 305 after multiple beam sweeping bursts 330 (e.g., beam response 310-a is responding to multiple beam transmissions 305-a transmitted in multiple beam sweeping bursts 330). Thus, the receiving UE 115 may determine beam responses 310-a, 310-b, 310-c, and up to beam response 310-N.

During the initial beam pairing procedure 300, a receiving UE 115 may measure a received signal strength indicator (RSSI) and a reference signal receive power (RSRP) for each transmission beam of a beam sweeping burst 315 or 330 (e.g., measure the RSSI and RSRP of the beam sweeping transmissions 305 received on a reception beam). The receiving UE 115 may calculate the RSRQ based on the measured RSSI and the measured RSRP. Similarly, the receiving UE 115 may derive the SINR based on the measurements. The receiving UE 115 may determine a collision with the transmission beam if the RSRQ or SINR is below an RSRQ or SINR threshold. Additionally, or alternatively, the receiving UE 115 may determine a collision with N beam sweeping transmissions 305 within one or more beam sweeping bursts 315 or 330 if an averaged RSRQ or SINR or a maximum RSRQ or SINR is below an RSRQ or SINR threshold. The threshold may be preconfigured, configured, or activated for collision detection.

After determining a collision associated with the Nbeam sweeping transmissions, the receiving UE 115 may indicate a NACK (e.g., a one-bit sequence like a one-bit HARQ NACK) to the transmitting UE 115 at a beam response occasion associated with a selected transmission beam (e.g., transmission beam with greatest signal quality (e.g., based on RSRQ, SINR or RSRP) of the transmitting UE 115. Additionally, or alternatively, as discussed with respect to FIG. 2, the receiving UE 115 may determine a selected best transmission beam (e.g., to pair with) of the transmitting UE 115 when the signal quality of the transmission beam is above a quality threshold (e.g., preconfigured, configured, or activated for best beam selection during initial beam pairing) or has the greatest signal quality of all the transmission beams associated with the transmitting UE 115. The receiving UE 115 may indicate an ACK (e.g., a one-bit sequence like a one-bit HARQ ACK) at the beam response occasion associated with the selected best transmission beam where the beam response occasion associated with the selected best transmission beam is an implicit indication of the selected best transmission beam of the transmitting UE 115.

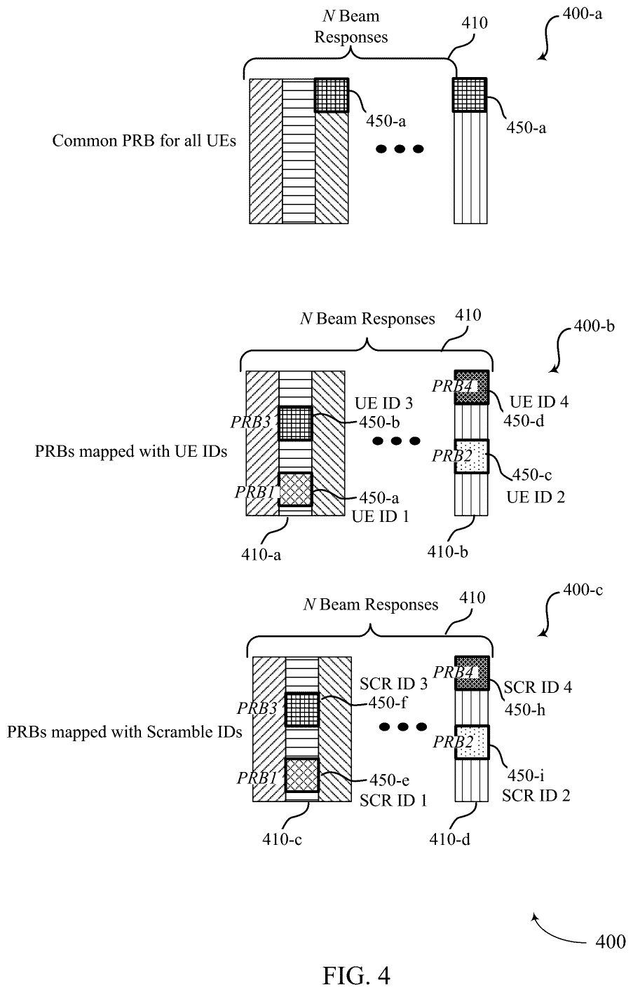

During the initial beam pairing procedure 300, one or more transmitting UEs 115 may sweep beam signals (e.g., Nbeam sweeping transmissions 305 within one or more bursts 315 or 330) that are scrambled with same or different scramble IDs (e.g., PSS or the like or SSS or the like). The sequence may be generated based on an ID, a CSI-RS, or the like, and the sequence may be initiated with an ID (referred to as the scramble ID) of the beam signals in N beam sweeping transmissions 305 within one or more bursts 315 or 330), over the same set resources. As discussed with respect to FIG. 4, the scramble IDs may be indicative of the respective transmitting UEs 115 associated with the beam sweeping burst 315 or 330, indicative of receiving UEs 115 associated with the beam sweeping burst 315 or 330, indicative of sidelink services associated with the beam sweeping burst 315 or 330, indicative of sidelink applications associated with the beam sweeping burst 315 or 330, or indicative of sidelink communication associated with the beam sweeping burst 315 or 330. The receiving UE 115 may descramble received beam signals (e.g., N beam sweeping transmissions 305 within one or more beam sweeping bursts 315 or 330) from one or more transmitting UEs 115, using a scramble ID for a respective transmitting UE 115 or receiving UE 115, a respective sidelink service or application, a respective sidelink communication, or the like. The receiving UE 115 may measure the RSRP of the descrambled beam signals (e.g., for finding a best transmitting beam of the respective beam sweeping burst(s) to pair with). The receiving UE 115 may measure the RSSI of the received beam signals (e.g., N beam sweeping transmissions 305 within one or more bursts 315 or 330) from one or more transmitting UEs 115 (e.g., combined beam signals from one or more transmitting UEs 115 without descrambling). Based on the measured RSRP of the descrambled beam signal and the measured RSSI, or any the like, the receiving UE 115 may calculate RSRQ or derive SINR. The receiving UE 115 may determine a collision if the RSRQ or SINR is below a threshold for collision detection during initial beam pairing, or select a best transmission beam (e.g., to pair with) with greatest signal quality (e.g., N beam sweeping transmissions 305) or with signal quality above a threshold. The transmitting UE 115 may monitor beam responses associated with the different transmission beams using different reception beams corresponding to the different transmission beams (e.g., different spatial directions) at different beam response occasions (e.g., different time resources or allocations). The transmitting UE 115 may monitor at each of N beam responses 310, using the reception beams corresponding to each transmission beam of N beam sweeping transmissions 305, for an ACK. The ACK may be indicative of a selected best transmission beam for initial beam pairing. The transmitting UE 115 may also monitor at each of N beam responses 310, using the reception beams corresponding to each transmission beam of N beam sweeping transmissions 305, for a NACK. The NACK may be indicative of a beam burst collision during initial beam pairing. In the case of receiving at least one NACK for collision, the transmitting UE 115 may determine to reselect resources for another one or more beam sweeping bursts 315 or 330.

In some aspects, for initial beam pairing, the receiving UE 115 may transmit an ACK for indicating a selected best transmission beam of the transmitting UE 115 to pair with, or a NACK for indicating a collision after multiple beam sweeping bursts 315 or 330 based on the measurements of transmission beams with different reception beams (e.g., using a first reception beam for the measurements of the first N beam sweeping transmissions and selecting a first best transmission beam in a first beam sweeping burst, a second reception beam for the measurements of the second N beam sweeping transmissions and selecting a second best transmission beam in a second beam sweeping burst, and so forth). The receiving UE 115 may select a reception beam (e.g., best reception beam of the first reception beam, the second reception beam, and so forth, that has the greatest signal quality) corresponding to the best transmission beam (with greatest RSRP, RSRQ or SINR using the selected best reception beam) of selected best transmission beams (e.g., the best transmission beam of the first best transmission beam, the second best transmission beam, and so forth, respectively using the first reception beam, the second reception beams, and so forth). The best reception beam of the receiving UE 115 and the best transmission beam of the transmitting UE 115 may be paired during initial beam pairing. In such examples, the best transmission beam of the transmitting UE 115 is indicated at the beam response occasion associated with the best transmission beam of the transmitting UE 115 using the transmission beam corresponding to the selected best reception beam at the receiving UE 115.

In some examples, additionally or alternatively (e.g., for beam management after initial beam pairing), the receiving UE 115 may transmit an ACK for indicating a selected best beam of the transmitting UE 115, or a NACK for indicating a collision within a beam sweeping burst 315, or after one or more beam sweeping bursts 330 based on the measurements of transmission beams using a reception beam (e.g., using the reception beam for the measurements of N beam sweeping transmissions). The best transmission beam of the transmitting UE 115 may be selected for transmission beam fine tuning, beam switching, beam failure recovery, or alike, where the beam response occasion for transmitting an indication (e.g., an ACK for the selected best transmission beam) is indicative of the best transmission beam of the transmitting UE 115.

In some examples, additionally or alternatively (e.g., for beam management after initial beam pairing), the receiving UE may transmit an ACK for indicating a selected best reception beam of the receiving UE 115 or a NACK for indicating a collision within a beam sweeping burst 315 or after one or more beam sweeping bursts 330. The ACK or NACK may be based on the measurements of same transmission beam with different reception beams (e.g., using N reception beams for the measurements of N beam sweeping transmissions with one transmission beam). The receiving UE 115 may select a reception beam (e.g., best reception beam) based on the greatest signal quality or a signal quality that is greater than a threshold. The threshold may be preconfigured, configured or activated for reception beam selection. The best reception beam of the receiving UE 115 may be selected for initial beam pairing, reception beam fine tuning, beam failure recovery, or the like. The beam response occasion for transmitting an indication (e.g., an ACK for the selected best reception beam) is indicative of the best reception beam of the receiving UE 115.

FIG. 4 shows an example of resource allocations 400 during initial beam pairing that support best beam selection for initial beam pairing or collision detection in accordance with one or more aspects of the present disclosure. The resource allocations 400 may include a common PRB resource allocation 400-a, a UE ID based PRB resource allocation 400-b, and a scramble ID based PRB resource allocation 400-c.

In some examples, the resource allocations 400 for different beam burst collision indications from different receiving UEs 115 may facilitate in identifying indications as being associated with respective UEs 115. For example, in the resource allocations 400, N beam responses 410 may include multiple beam responses for multiple transmission beams and each of the beam responses 410 may correspond to a beam response allocation in frequency resources (e.g., allocation with different PRBs 450 of a beam response occasion), which may be allocated as discussed herein. The common PRB resource allocation 400-a may include a common PRB 450-a that is the same or common to all receiving UEs 115 for transmitting the collision indications in the multiple beam responses (e.g., NACK sequence indications (from different receiving UEs 115) associated with a collision are overlapped at the common PRB 450-a (e.g., PRB_bestBeam) of the beam response occasion that is associated with the selected beam for transmitting the collision indication). The common PRB 450-a (e.g., PRB_commonCollision) may be preconfigured, configured, activated, or the like, as the parameter(s) for collision indication.

In the UE ID based PRB resource allocation 400-b, a PRB may be mapped with a receiving UE's ID using the following mapping equation:

$${PRB\_collision}_{UE\_ID} = {UE}_{ID} mod {PRBs\_collision}_{total} \qquad ( 1 )$$

As an example, thePRBs_collisionₜₒₜₐₗ>4, where the total frequency resources (e.g., PRBs) for collision indications at a beam response occasion may be preconfigured, configured, activated, or the like, as the parameter(s) for collision indication. As illustrated in 400-b, a first beam response 410-a may include a first PRB 450-a that is mapped to a first UE ID (UE ID as “1” which may correspond to PRB_collision_{UE_ID}=UE_{ID} mod PRBs_collisionₜₒₜₐₗ=1 mod PRBs_collisionₜₒₜₐₗ=1) and a second PRB 450-b that is mapped to a second UE ID (UE ID as “3” which may correspond to PRB_collision_{UE_ID}UE_{ID} mod PRBs_collisionₜₒₜₐₗ=3 mod PRBs_collisionₜₒₜₐₗ=3). A second beam response 410-b may include a third PRB 450-c that is mapped to a third UE ID (UE ID as “2” which may correspond to PRB_collision_{UE_ID}UE_{ID} mod PRBs_collisionₜₒₜₐₗ=2 mod PRBs_collisionₜₒₜₐₗ=2) and a fourth PRB 450-d that is mapped to a fourth UE ID (UE ID as “4” which may correspond to PRB_collision_{UE_ID}=UE_{ID} mod PRBs_collisionₜₒₜₐₗ=4 mod PRBs_collisionₜₒₜₐₗ=4). The PRBs 450 may be indicative of collision indications transmitted in a frequency resource portion (e.g., block) of the beam response occasion. The receiving UE IDs may facilitate in identifying the respective receiving UE 115 that transmitted the collision indication in the beam response occasion. For example, if the receiving UE having an ID as “3” transmits an indication, the resource may be allocated at PRB 450-b for the receiving UE ID 3.

In the scramble ID based PRB resource allocation 400-c, a PRB may be mapped with a scramble ID (e.g., SCR ID) using the following mapping equation:

$${PRB\_collision}_{scr\_ID} = {Scramble}_{ID} mod {PRBs\_collision}_{total} \qquad ( 2 )$$

As an example, the PRBs_collisionₜₒₜₐₗ>4, where the total frequency resources (e.g., PRBs) for collision indications at a beam response occasion may be preconfigured, configured, activated, or the like, as the parameter(s) for collision indication. As illustrated in 400-c, a first beam response 410-c may include a first PRB 450-e that is mapped to first scramble ID (SCR ID as “1” which may correspond to PRB_collision_{scr_ID}=Scramble_{ID} mod PRBs_collisionₜₒₜₐₗ=1 mod PRBs_collisionₜₒₜₐₗ=1) and a second PRB 450-f that is mapped to a second scramble ID (SCR ID as “3” which may correspond to PRB_collision_{scr_ID}±Scramble_{ID} mod PRBs_collisionₜₒₜₐₗ=3 mod PRBs_collisionₜₒₜₐₗ=3). A second beam response 410-d may include a third PRB 450-i that is mapped to a third scramble ID (SCR ID as “2” which may correspond to PRB_collision_{scr_ID}-Scramble_{ID} mod PRBs_collisionₜₒₜₐₗ=2 mod PRBs_collisionₜₒₜₐₗ=2) and a fourth PRB 450-h that is mapped to a fourth scramble ID (SCR ID as “4” which may correspond to PRB_collision_{scr_ID}=Scramble_{ID} mod PRBs_collisionₜₒₜₐₗ=4 mod PRBs_collisionₜₒₜₐₗ=4). The PRBs 450 may be indicative of collision indications transmitted by receiving UEs in a frequency resource portion of the beam response occasion. The scramble IDs may facilitate in identifying the respective receiving UE 115 that transmitted the collision indication for a respective transmitting UE 115, a respective sidelink service or application, a respective sidelink communication, or the like.

In some examples, the resource allocations 400 for different selected best beams for initial beam pairing from different receiving UEs 115 may facilitate in identifying best beam indications as being associated with respective UEs 115. For example, in the resource allocations 400, N beam responses 410 may include multiple beam responses for multiple transmission beams and each of the beam responses 410 may correspond to a beam response allocation in frequency resources (e.g., allocation with different PRBs 450 of a beam response occasion), which may be allocated as discussed herein. The common PRB resource allocation 400-a may include a common PRB 450-a (e.g., PRB_bestBeam) that is the same or common to all receiving UEs 115. The common PRBs 450-a may be used for transmitting the best beam indications in the multiple beam responses (e.g., ACK sequence indications (from different receiving UEs 115) associated with best beams that may be overlapped at the common PRB 450-a (e.g., PRB_bestBeam) of the beam response occasion associated to the best beam for beam pairing). In some examples, the common PRB 450-a (e.g., PRB_commonBestBeam) may be preconfigured, configured, activated, or the like, as the parameter(s) for best beam indication for initial beam pairing. The common frequency resource portion for beat beam indications (e.g., PRB_commonBestBeam for ACK sequence indications) may be different from the common frequency resource portion for collision indications (e.g., PRB_commonCollision for NACK sequence indications) to avoid overlaying between overlapped ACK indications from a group of receiving UEs 115 and overlapped NACK indications from another group of receiving UEs 115.

In the UE ID based PRB resource allocation 400-b, a PRBs 450 may be mapped with a receiving UE's ID using the following mapping equation:

$${PRB\_bestBeam}_{UE\_ID} = {UE}_{ID} mod {PRBs\_bestbeam}_{total} \qquad ( 3 )$$

As an example, the PRBs_bestBeamₜₒₜₐₗ>4, where the total frequency resources (e.g., PRBs) for best beam indications at a beam response occasion may be preconfigured, configured, activated, or the like, as the parameter(s) for best beam indication for initial beam pairing. As illustrated in 400-b, a first beam response 410-a may include a first PRB 450-a that is mapped to a first UE ID (UE ID as “1” which may correspond to PRB_bestBeam_{UE_ID}=UE_{ID} mod PRBs_bestBeamₜₒₜₐₗ=1 mod PRBs_bestBeamₜₒₜₐₗ=1) and a second PRB 450-b that is mapped to a second UE ID (UE ID as “3” which may correspond to PRB_bestBeam_{UE_ID}UE_{ID} mod PRBs_bestBeamₜₒₜₐₗ=3 mod PRBs_bestBeamₜₒₜₐₗ=3). A second beam response 410-b may include a third PRB 450-c that is mapped to a third UE ID (UE ID as “2” which may correspond to PRB_bestBeam_{UE_ID}UE_{ID} mod PRBs_bestBeamₜₒₜₐₗ=2 mod PRBs_bestBeamₜₒₜₐₗ=2) and a fourth PRB 450-d that is mapped to a fourth UE ID (UE ID as “4” which may correspond to PRB_bestBeam_{UE_ID}=UE_{ID} mod PRBs_bestBeamₜₒₜₐₗ=4 mod PRBs_bestBeamₜₒₜₐₗ=4). The PRBs 450 may be indicative of best beam indications transmitted in a frequency resource portion (e.g., block) of the beam response occasion, where the frequency resource portion for best beam indications (e.g., including the PRBs_bestBeamₜₒₜₐₗ PRBs for ACK sequence indications from different receiving UEs 115) may be the same. For example, the best beam indication ACK sequence may be orthogonal with the collision indication NACK sequence (e.g., with 180-degree cyclic shift like the ACK and NACK sequences of HARQ feedback) or different from the frequency resource portion for collision indications (e.g., including the PRBs_collisionₜₒₜₐₗ PRBs for NACK sequence indications from different receiving UEs 115). The receiving UE IDs may facilitate in identifying the respective receiving UE 115 that transmitted the best beam indication for initial beam pairing in the beam response occasion. For example, if the receiving UE with ID as “3” transmits a best beam indication for beam pairing, the resource may be allocated for the receiving UE at PRB 450-b.

In the scramble ID based PRB resource allocation 400-b, a PRB may be mapped with a scramble ID using the following mapping equation:

$${PRB\_bestBeam}_{UE\_ID} = {SCR}_{ID} mod {PRBs\_bestbeam}_{total} \qquad ( 4 )$$

In some examples, the PRBs_bestBeamₜₒₜₐₗ>4, where the total frequency resources (e.g., PRBs) for best beam indications at a beam response occasion may be preconfigured, configured, activated, or the like, as the parameter(s) for best beam indication for initial beam pairing. As illustrated in 400-c, a first beam response 410-a may include a first PRB 450-e that is mapped to a first scramble ID (SCR ID as “1” which may correspond to PRB_bestBeam_{SCR_ID}=SCR_{ID} mod PRBs_bestBeamₜₒₜₐₗ=1 mod PRBs_bestBeamₜₒₜₐₗ=1) and a second PRB 450-f that is mapped to a second scramble ID (SCR ID as “3” which may correspond to PRB_bestBeam_{SCR_ID}=SCR_{ID} mod PRBs_bestBeamₜₒₜₐₗ=3 mod PRBs_bestBeamₜₒₜₐₗ=3). A second beam response 410-b may include a third PRB 450-i that is mapped to a third scramble ID (SCR ID as “2” which may correspond to PRB_bestBeam_{SCR_ID}=SCR_{ID} mod PRBs_bestBeamₜₒₜₐₗ=2 mod PRBs_bestBeamₜₒₜₐₗ=2) and a fourth PRB 450-h that is mapped to a fourth scramble ID (SCR ID as “4” which may correspond to PRB_bestBeam_{SCR_ID}=SCR_{ID} mod PRBs_bestBeamₜₒₜₐₗ=4 mod PRBs_bestBeamₜₒₜₐₗ=4). The PRBs 450 may be indicative of best beam indications transmitted in a frequency resource portion (e.g., block) of the beam response occasion. In some examples, the frequency resource portion for best beam indications (e.g., including PRBs_bestBeamₜₒₜₐₗ PRBs for ACK sequence indications from different receiving UEs 115) may be the same (if the best beam indication ACK sequence is orthogonal with the collision indication NACK sequence) or different from the frequency resource portion for collision indications (e.g., including PRBs_collisionₜₒₜₐₗ PRBs for NACK sequence indications from different receiving UEs 115). The scramble IDs may facilitate in identifying the respective transmitting UE, respective sidelink service or application, respective sidelink communication, or the like by the receiving UE 115 that transmitted the best beam indication for initial beam pairing in the beam response occasion. For example, if the receiving UE 115 transmits a beast beam indication associated with scramble ID as “3” for beam pairing, the resource may be allocated for the receiving UE at PRB 450-f.

FIG. 5 shows an example of a process flow 500 that supports best beam selection for beam pairing or collision detection for initial beam pairing in accordance with one or more aspects of the present disclosure. The process flow 500 may implement aspects of or may be implemented by aspects of the wireless communications system 100 or the wireless communications system 200. For example, the process flow 500 may include a UE 115-d and a UE 115-e, which may be an example of a UE 115 as described herein. In the following description of the process flow 500, the operations performed by the UE 115-d and the UE 115-e may be performed in different orders or at different times than the exemplary order shown. Some operations may also be omitted from the process flow 500, or other operations may be added to the process flow 500. Further, while operations in the process flow 500 are illustrated as being performed by the UE 115-d and the UE 115-e, the examples herein are not to be construed as limiting, as the described features may be associated with any quantity of different devices.

At 510, the transmitting UE 115-d may receive sidelink configuration and at 515, the receiving UE 115-e may receive sidelink configuration. For example, the UEs 115 may be preconfigured or configured with sidelink FR2 operation parameters (e.g., SL-FR2 configuration) for one or more sidelink services (e.g., identified via service type ID(s) or application ID(s) from upper layer, such as service layer or application layer). In some examples, the sidelink FR2 operation parameters may include parameters for sidelink beam management, such as resources (e.g., in time and frequency) for beam management, beam sweeping burst patterns such as a burst duration and burst period with a quantity of beams and/or a quantity of panels (e.g., same or different patterns for initial beam pairing, beam maintenance, beam monitoring or measurements, and beam failure detection and recovery), and so forth. In some examples, the beam management may include beam fine tuning, the beam monitoring or measurements, or the beam failure detection and recovery. In some examples, the sidelink FR2 operation parameters may include resources (e.g., in time and frequency) for a beam report (e.g., selected best transmission beams and/or reception beams for initial beam pairing, beam fine tuning, or beam failure recovery), beam measurements (e.g., for beam monitoring or candidate beam selection for beam recovery), and so forth. In some examples, the sidelink FR2 operation parameters may include one or more configuration for best beam selection (e.g., one or more conditions or thresholds for selecting one or more transmission beams of transmitting UE 115 beam sweeping transmissions) and best beam indication (e.g., common resources or dedicated resources for different UEs 115 or services), beam sweeping collision detection (e.g., conditions or thresholds for collision detection) and beam sweeping collision indication (e.g., common resources or dedicated resources for different UEs or services), and so forth. At 520, the transmitting UE 115-d may select resources for one or more beam sweeping bursts, for example, based on the received sidelink configuration. The transmitting UE 115-d may determine a beam sweeping burst pattern for initial beam pairing and may select resources accordingly for the determined one or more beam sweeping bursts (e.g., based on the received parameters or configurations).

At 525, the receiving UE 115-e may monitor for beam sweeping transmissions in one or more beam sweeping bursts (e.g., based on the received parameters or configurations) and collect beam measurements, for example, for determining beam responses. For example, the determining beam responses may include determining the best beam for beam pairing or beam sweeping collision based on the received parameters or configurations for best beam selection or collision detection. At 530, the transmitting UE 115-d may transmit beam sweeping transmissions in a first one or more beam sweeping bursts. For example, the transmitting UE 115-d may transmit, and the receiving UE 115-e may monitor, the first one or more beam sweeping bursts for initial beam pairing. The receiving UE 115-e may monitor the beam sweeping transmissions and conduct beam measurement on each beam transmission of the one or more beam sweeping bursts. For example, the receiving UE 115-e may descramble the beam signal (e.g., beam sweeping transmission) that is transmitted on each transmission of the one or more beam sweeping bursts via one or more receive beams using a sequence generated with a scramble ID. The scramble ID may be derived from a service type ID, an application ID, a sidelink communication ID (e.g., link ID), a transmitting UE ID (if known to the receiving UE 115-e), a receiving UE ID or a combination thereof. The receiving UE 115-e may measure the RSRP of the descrambled beam signal of each transmission on each transmission beam, measure the RSSI of each transmission on each transmission beam without descrambling, and then calculate the RSRQ or SINR based on the RSRP and RSSI measurements.

At 540, the receiving UE 115-e may determine best beam for beam pairing or beam sweeping collision (e.g., one or more beam sweeping collisions). For example, the receiving UE 115-e may determine a best beam for beam pairing if the selected beam has the highest RSRQ or SINR and/or has an RSRQ or SINR above a threshold. The threshold may be preconfigured, configured, or activated for best beam selection for initial beam pairing with the transmitting UE 115-d. As another example, the receiving UE 115-e may determine one or more beam sweeping collision detections if the calculated RSRQ or SINR is below a threshold preconfigured, configured, or activated for collision detection and then select a transmission beam with the highest RSRQ or SINR for the beam response occasion to be used for collision indication.

At 545, the transmitting UE 115-d may monitor beam response indications at each beam response occasion (e.g., ACK for beat beam indication or NACK indication for collision indication). At 550, the receiving UE 115-e may transmit the indication of the beam sweeping collision. In some examples, the receiving UE 115-e may transmit the indications using the transmit beam corresponding to the receive beam of the receiving UE 115-e for detecting the collision at the beam response occasion (e.g., resource in time). The beam response occasion may be associated with the selected beam (e.g., with the highest RSRQ or SINR) for the one or more beam sweeping bursts from the transmitting UE 115-d. The transmitting UE 115-d may monitor one or more indications of beam sweeping collision using receive beams of the transmitting UE 115-d at each of the beam response occasions. The receive beams may correspond to the transmission beams of the transmitting UE 115-d in the one or more beam sweeping burst. The transmission beams in the one or more beam sweeping bursts may be associated with the beam response occasions (e.g., resource in time). The frequency resources at the beam response occasions may be allocated by PRBs, as discussed with respect to FIG. 4. For example, the resource may be allocated based on a common resource that is common to all UEs 115, a dedicated resource associated with a UE (e.g., mapped with receiving UE ID), or a sidelink service, sidelink application, sidelink communication, or transmitting UE (e.g., mapped with the scramble ID derived from the service type ID or application ID or link ID or transmitting UE ID).

After receiving the indication of collisions, at 560, the transmitting UE 115-d may reselect beam sweeping bursts and associated resources. That is, the transmitting UE 115-d may reselect resources for the determined beam sweeping burst based on beam sweeping collision indications. At 570, the receiving UE 115-e may monitor beam sweeping transmissions and measurements. At 575, the transmitting UE 115-d may transmit the beam sweeping transmissions in a second one or more beam sweeping bursts. That is, the transmitting UE 115-d may transmit the beam sweeping transmissions in the second one or more beam sweeping bursts, and the receiving UE 115-e may monitor the second one or more beam sweeping bursts including the beam sweeping transmissions for initial beam pairing. At 580, the receiving UE 115-e may determine the best transmission beam and/or reception beam (e.g., best transmission beam and/or best reception beam for initial beam pairing). For example, the receiving UE 115-e may determine no beam sweeping collision detections if the calculated RSRQ or SINR is above a threshold preconfigured or configured or activated for determining no collision). The threshold may be the same or higher than the threshold for collision detection. The receiving UE 115-e may select a best transmission beam of the multiple transmission beams of the transmitting UE 115-d. The receiving UE 115-e may determine the best transmission beam based on a highest RSRQ or highest SINR value, or when the calculated RSRQ or SINR is above a threshold The threshold may be preconfigured, configured, or activated for best transmission beam selection for initial beam pairing, and in some examples, the threshold may be same or higher than the threshold for determining no collision.

At 585, the transmitting UE 115-e may monitor beam response indications at each beam response occasion using the reception beam corresponding the transmission beam associated with the beam response occasion. At 590, the receiving UE 115-e may transmit the indication of the best beam indication. That is, the receiving UE 115-e may transmit the best beam indication using the transmission beam that corresponds to a reception beam of the receiving UE 115-e for selecting the best transmission beam at the beam response occasion associated with the best transmission beam of the one or more beam sweeping bursts. That is, the receiving UE 115-e may determine a transmission beam (of the receiving UE 115-e) corresponding to the reception beam (of the receiving UE 115-e) for selecting the best transmission beam (of the transmitting UE 115-d) based on beam correspondence between transmission beam and reception beam at a UE 115. The correspondence may be due to reciprocal property for radio propagation between antennas of two UEs 115 (e.g., received power for a transmission from a first UE 115 to a second UE 115 is the same as the received power for a transmission from the second UE 115 to the first UE 115). The transmitting UE 115-d may monitor the indication of the best transmission beam using the receive beams corresponding respectively to the transmission beams in the one or more beam sweeping bursts at respective beam response occasions. At 595, the transmitting UE 115-d may transmit using the best transmission beam as indicated, and the receiving UE 115-e may receive a confirmation message to complete the initial beam pairing. The receiving UE 115-e may receive the confirmation message using the reception beam that is selected based on the transmission beam. The confirmation message may include a direct communication request message to start PC5 connection establishment procedure for a sidelink communication between the transmitting UE 115-d and receiving UE 115-e.

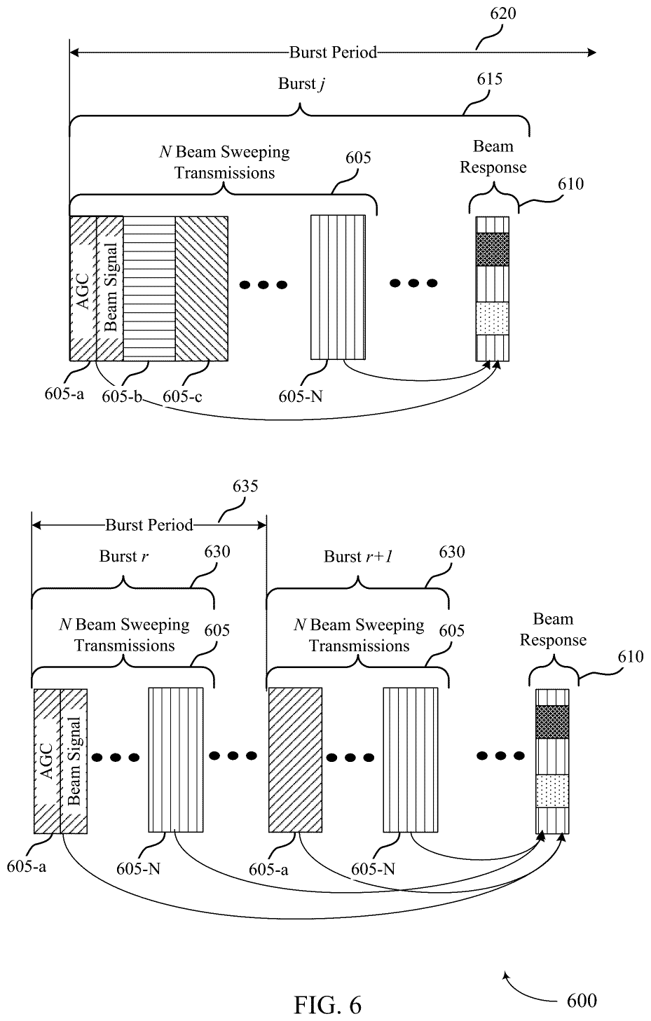

FIG. 6 shows an example of a beam sweeping burst 600 for beam management that supports best beam selection for beam management after initial beam pairing or collision detection in accordance with one or more aspects of the present disclosure. The beam sweeping burst 600 may include N beam sweeping transmissions 605, where N is greater than 1. Each beam sweeping transmission or beam transmission may include at least an AGC symbol or a beam signal, where the AGC symbol may include a signal same or similar to the beam signal. The beam signal may contain m-sequence or sequences (e.g., PSS-like or SSS-like signal). The sequences may be generated based on a scramble ID for a sidelink service or application, a sidelink communication, a transmitting or receiving UE 115, an identifier or index of a beam signal of a beam sweeping burst, or an indication of TCI state of a beam signal of a beam sweeping burst. The beam signal may include a pseudo-random sequence (e.g., CSI-RS signal or the like) that is initiated with a scramble ID for a sidelink service or application, a sidelink communication, a transmitting or receiving UE, or an ID or index of a beam signal of a beam sweeping burst, or an indication of TCI state of a beam signal of a beam sweeping burst. For example, the Nbeam sweeping transmissions 605 may include a beam sweeping transmissions 605-a, 605-b, 605-c, and up to beam sweeping transmission 605-N. A transmitting UE 115 may transmit the beam sweeping transmissions 605 in a beam sweeping burst 615 (e.g., such as burst j including beam response 610) or a beam sweeping burst 630 (e.g., such bursts r or r+1 without beam response 610), and one or more beam sweeping bursts 615 or beam sweeping bursts 630 (e.g., r, r+1) may occur during a burst period 620 or a burst period 635 respectively. A receiving UE 115 may receive the beam sweeping transmission 605 and determine a beam response 610.

The beam sweeping burst 600 may implement aspects of the initial beam pairing procedure 300. For example, the beam sweeping burst 600 includes beam sweeping transmissions 605 and a beam response 610, which may be examples of or operate similarly to beam sweeping transmissions 305 and beam responses 310, as discussed with respect to FIG. 3. However, in beam sweeping burst 600, the single beam response 610 may correspond to the N beam sweeping transmissions 605 in one or more beam sweeping bursts 615 or 630. Since the beam sweeping burst 600 occurs after the initial beam pairing, a receiving UE 115 and the transmitting UE 115 may already be paired with a beam pair link and may use sidelink communications via an active transmission beam from the transmitting UE 115 and an active reception beam at the receiving UE 115 (paired to the active transmission beam). Thus, the receiving UE 115 may determine the beam response associated with the active transmission beam of the transmitting UE 115 and active reception beam of the receiving UE 115. In this manner, the transmitting UE 115 may monitor and receive a beam response 610 at one beam response occasion using the reception beam corresponding to the active transmission beam. Monitoring and receiving a beam response 610 in one beam response occasion may be more efficient and a shorter duration than determining multiple beam responses performed during the initial beam pairing procedure.

Accordingly, the receiving UE 115 may determine a selected transmission beam as the best transmission beam (e.g., for transmitting beam fine tuning, beam switching, beam recovery, or the like) of the transmitting UE 115 when the signal quality (e.g., measured or indicated by RSRQ or SINR or RSRP) of the selected transmission beam is above a signal quality threshold (or has the greatest signal quality of all the transmission beams associated with the transmitting UE 115. Alternatively, the receiving UE 115 may determine a beam burst collision if the RSRQ or SINR is below a threshold. The receiving UE 115 may indicate an ACK for best transmission beam or indicate a NACK for beam collision at the beam response 610 (or beam response occasion) associated with the beam sweeping burst 615 or beam sweeping bursts 630. One or more transmitting UEs 115 may sweep different beam signals scrambled with different scramble IDs (e.g., indicative of transmitting or receiving UEs, or sidelink services or applications, or sidelink communications, or alike) for N beam sweeping transmissions 605 with one or more beam sweeping bursts 615 or 630 over the same set resources. The transmitting UEs 115 may monitor for best transmission beam indications or beam collision indications at the beam response 610 with reception beams corresponding to the active transmission beams. For example, a transmitting UE 115 may monitor for an ACK, which may indicate a best transmission beam, or monitor for a NACK, which may indicate a beam burst collision, using the active reception beam corresponding to the active transmission beam.

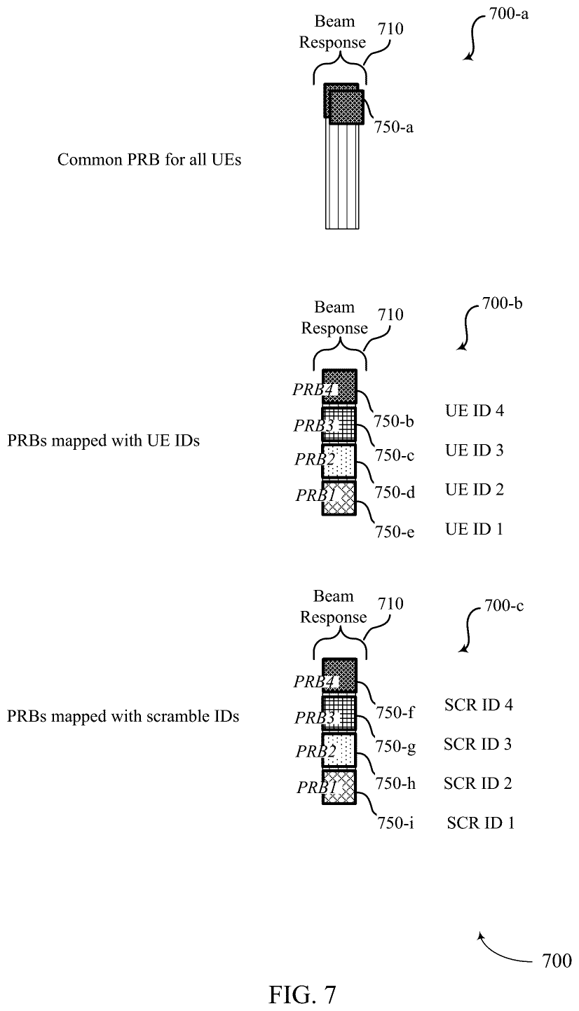

FIG. 7 shows an example of resource allocations 700 for beam management that support best beam selection for beam management after initial beam pairing and/or collision detection in accordance with one or more aspects of the present disclosure. The resource allocations 700 may include a common PRB resource allocation 700-a, a UE ID based PRB resource allocation 700-b, and a scramble ID based PRB resource allocation 700-c. The resource allocations 700 may implement aspects of the resource allocations 400. For example, the resource allocations 700 include a beam response allocation in frequency resources associated with a beam response 710, where the beam response allocation in frequency resources is allocated based on PRBs, which may be examples of or operate similarly to the PRBs 450 and resource allocations 400, as discussed with respect to FIG. 4. However, the beam response 710 for beam management after initial beam pairing includes a single beam response 710, as discussed with respect to FIG. 6, for multiple beam sweeping transmissions.

In the common PRB resource allocation 700-a, the beam response 710 may include a first PRB 750-a for best beam indication (e.g., an ACK sequence) that is the same or common to all UEs 115 in the beam response occasion and a second PRB 750-a for collision indication (e.g., a NACK sequence) that is the same or common to all UEs 115 in the beam response occasion. In some examples, the first PRB 750-a for best beam indication and the second PRB 750-a for collision indication may not be the same. The common PRB 750-a may be preconfigured, configured, activated, or alike. That is, the resource may be commonly allocated to all UEs 115 at PRB 750-a.

In the UE ID based PRB resource allocation 700-b, a PRB 750 may be mapped with a receiving UE's ID using the following mapping equation for best beam indications:

$${PRB\_bestBeam}_{UE\_ID} = {UE}_{ID} mod {PRBs\_bestbeam}_{total} \qquad ( 5 )$$

In some examples, a PRB 750 may be mapped with a receiving UE's ID using the following mapping equation for collision indications at the beam response:

$${PRB\_collision}_{UE\_ID} = {UE}_{ID} mod {PRBs\_collision}_{total} \qquad ( 6 )$$

In some examples, the PRBs_bestBeamₜₒₜₐₗ>4 for total frequency resources and for best beam indications. In some examples, thePRBs_collisionₜₒₜₐₗ>4 for total frequency resources and for collision indications. The total frequency resources for collision indications may be preconfigured, configured, activated, or alike, as the parameter(s) for best beam indication or collision indication. As illustrated in 700-b, the beam response 710 may include a first PRB 750-b that is mapped to a first receiving UE ID (UE ID as “4” mapped to PRB_bestBeam_{UE_ID}=4 or PRB_collision_{UE_ID}=4), a second PRB 750-c that is mapped to a second receiving UE ID (UE ID as “3” mapped to PRB_bestBeam_{UE_ID}=3 or PRB_collision_{UE_ID}=3), a third PRB 750-d that is mapped to a third receiving UE ID (UE ID as “2” mapped to PRB_bestBeam_{UE_ID}=2 or PRB_collision_{UE_ID}=2), and a fourth PRB 750-e that is mapped to a fourth receiving UE ID (RX UE ID as “1” mapped to PRB_bestBeam_{UE_ID}=1 or PRB_collision_{UE_ID}=1). The PRBs 750 may be indicative of best beam indications or collision indications transmitted in a frequency resource portion (e.g., a block) of the beam response 710. The UE IDs may facilitate in identifying the respective receiving UE 115 that transmitted the best beam indication or collision indication in the beam response occasion, as discussed with respect to FIG. 4. In some examples, the different PRBs 750 in the UE ID based PRB resource allocation 700-b, may be indicative of different receiving UEs 115 that are mapped with UE IDs.

In the scramble ID based PRB resource allocation 700-c, a PRB may be mapped with a scramble ID (e.g., SCR ID) using the following mapping equation for best beam indications:

$${PRB}_{{bestBecome}_{{UE}_{ID}}} = {UE}_{ID} mod {PRBs}_{{bestBeam}_{total}} \qquad ( 7 )$$

In some examples, a PRB may be mapped with a scramble ID (e.g., SCR ID) using the following mapping equation for collision indications at the beam response:

$${PRB\_collision}_{scr\_ID} = {Scramble}_{ID} mod {PRBs\_collision}_{total} \qquad ( 8 )$$

In some examples, the PRBs_bestBeamₜₒₜₐₗ>4 for the total frequency resources and for best beam indications. In some examples, the PRBs_collisionₜₒₜₐₗ>4 for total frequency resources and for collision indications. The total frequency resources for collision indications may be preconfigured, configured, activated, or alike, as the parameter(s) for best beam indication or collision indication. As illustrated in 700-c, the beam response 710 may include a first PRB 750-f that is mapped to a first scramble ID (SCR ID as “4” mapped to PRB_bestBeam_{UE_ID}=4 or PRB_collision_{UE_ID}=4), a second PRB 750-g that is mapped to a second scramble ID (SCR ID as “3” mapped to PRB_bestBeam_{UE_ID}=3 or PRB_collision_{UE_ID}=3), a third PRB 750-h that is mapped to a third scramble ID (SCR ID as “2” mapped to PRB_bestBeam_{UE_ID}=2 or PRB_collision_{UE_ID}=2), and a fourth PRB 750-i that is mapped to a fourth scramble ID (SCR ID as “1” mapped to PRB_bestBeam_{UE_ID}=1 or PRB_collision_{UE_ID}=1). The PRBs 750 may be indicative of best beam indications or collision indications transmitted in a frequency resource portion of the beam response 710. The scramble IDs may facilitate in identifying the respective transmitting UE 115, respective sidelink service or application, respective sidelink communication, or alike by the receiving UE 115 that transmitted the beast beam indication or collision indication in the beam response occasion. For example, the receiving UE 115 may use the scramble ID that corresponds to a respective transmitting UE 115 to identify the transmitting UE 115.

FIG. 8 shows an example of a process flow 800 that supports best beam selection for beam management after initial beam pairing or collision detection in accordance with one or more aspects of the present disclosure. The process flow 800 may implement aspects of or may be implemented by aspects of the wireless communications system 100 or the wireless communications system 200. For example, the process flow 800 may include a UE 115-f and a UE 115-g, which may be an example of a UE 115 as described herein. In the following description of the process flow 800, the operations performed by the UE 115-f and the UE 115-g may be performed in different orders or at different times than the exemplary order shown. Some operations may also be omitted from the process flow 800 or other operations may be added to the process flow 800. Further, while operations in the process flow 800 are illustrated as being performed by the UE 115-f and the UE 115-g, the examples herein are not to be construed as limiting, as the described features may be associated with any quantity of different devices.

Operations 810, 815, and 820, and 895, may operate as discussed with respect to 510, 515, 520, and 595 of FIG. 5, respectively. Operations 825, 830, 835, and 840 may correspond to configuring beam management parameters including best beam selection and indication parameters and collision detection and indication parameters. Operations 845, 850, 855, and 860 may correspond to activating beam management parameters including best beam selection and indication parameters and collision detection and indication parameters. Operations 865, 870, 875, 880, 885, 890, and 805 may correspond to a beam management procedure for beam maintenance (e.g., beam fine tuning or beam monitoring). During configuration of beam management parameters, at 825, the receiving UE 115-g may transmit a UE capability with beam management or UE information or UE assistance information with preferred beam management parameters. For example, the receiving UE 115-g may transmit and the transmitting UE 115-f may receive, a UE capability message including beam management parameters. The beam management parameters may include a quantity of panels, a quantity of total beams or beams per panel, types of beams (e.g., narrow or wide), beam switching time, beam detecting or selecting capability, collision detection capability (e.g., supporting or not supporting), and so forth. In some examples, the receiving UE 115-g may transmit a sidelink UE information message or sidelink UE assistance information message including preferred beam management parameters such as beam sweeping and report resources, beam sweeping patterns or period, condition for triggering beam sweeping. The sidelink UE information message or sidelink UE assistance information message may indicate UE preferred parameters for best beam selection and indication or collision detection and indication parameters (e.g., thresholds for beam selection or collision detection, resources for a best beam indication and/or a collision indication).

At 830, the transmitting UE 115-f may determine the beam management parameters. For example, the transmitting UE 115-f may determine beam management parameters including best beam selection and indication parameters and beam sweeping collision detection and indication parameters based on the received UE capability or preferred beam management parameters. At 835, the transmitting UE 115-f may transmit configuration of the management parameters including best beam selection and indication parameters and beam sweeping collision detection and indication parameters to the receiving UE 115-g. At 840, the receiving UE 115-g may transmit acceptance or rejection of the beam management configuration. For example, the transmitting UE 115-f may transmit, and the receiving UE 115-g may receive, a configuration for beam management parameters (e.g., direct communications (PC5) RRC configuration message). The beam management parameters may include resources for beam sweeping, thresholds for best beam selection and sweeping collision detection, and resources for best beam indication and beam sweeping collision indication (e.g., common allocation or dedicated allocation for different UEs or sidelink services). The receiving UE 115-g may indicate whether the configuration is accepted or rejected (e.g., PC5 RRC configuration complete message).

For activating beam management parameters, at 845, the receiving UE 115-g may transmit sidelink RSRP, RSSI, RSRQ, and/or SINR measurements to the transmitting UE 115-f. At 850, the transmitting UE 115-f may update beam management parameters based on the received beam measurements (e.g., update the threshold for best beam selection or beam sweeping collision detection). At 855, the transmitting UE 115-f may activate beam management parameters and at 860, the receiving UE 115-g may transmit acceptance or rejection of the beam management parameters. For example, the transmitting UE 115-f may transmit, and the receiving UE 115-g may receive, an activation of the updated beam management parameters (e.g., via a PC5 MAC CE) including at least resources for beam sweeping, thresholds for beam selection, thresholds for beam sweeping collision detection, resources for best beam indication, resources for beam sweeping collision indications (e.g., common allocation or dedicated allocation for different UEs or sidelink services), and so forth. The receiving UE 115-g may indicate whether the activation is accepted or rejected (e.g., via an ACK or NACK to the MAC CE).

For beam management after initial beam pairing such as beam maintenance, at 865, the transmitting UE 115-f may determine resources for one or more beam sweeping burst (e.g., for beam transmission or reception fine tuning, for beam monitoring or beam switching, for beam recovery, or the like). For example, the transmitting UE 115-f may determine a beam sweeping pattern for one or more beam sweeping burst (e.g., based on the configuration or activation) for transmission beam or reception beam fine tuning or beam monitoring (measurement and report) for beam maintenance, or candidate beam selection for beam failure recovery. The transmitting UE 115-f may update beam management parameters based on the received beam measurements (e.g., update the beam sweeping burst pattern (longer or shorter sweeping, quantity of bursts, etc.), threshold for best beam selection, threshold for beam sweeping collision detection, or resources for best beam indication or collision indication).

At 870, the receiving UE 115-g may monitor beam sweeping transmissions and collect beam measurements, and at 875, the transmitting UE 115-f may transmit beam sweeping transmissions in one or more beam sweeping bursts based on the updated beam management parameters. For example, the receiving UE 115-g may conduct beam measurements on each transmission of the one or more beam sweeping bursts.

At 880, the receiving UE 115-g may determine one or more beam sweeping collision detections. At 885, the receiving UE 115-g may transmit the indication of the beam sweeping collisions using the active transmission beam (corresponding to the active reception beam of the receiving UE 115-g) and the transmitting UE 115-f may monitor one or more indications of beam sweeping collisions using the active receive beam at the beam response occasion. The frequency resources (e.g., PRB allocation) may be common or dedicated to different UEs 115 or services at the beam response occasion.

At 890, the transmitting UE 115-f may reselect resources for the determined one or more beam sweeping bursts based on received beam sweeping collision indication. At 890, receiving UE 115-g may determine a best beam for transmission beam fine tuning or reception beam fine tuning, or candidate beam for beam switching or beam recovery. At 805, the transmitting UE 115-f may transmit, and the receiving UE 115-g may monitor, one or more beam sweeping bursts for the determined one or more beam sweeping bursts.

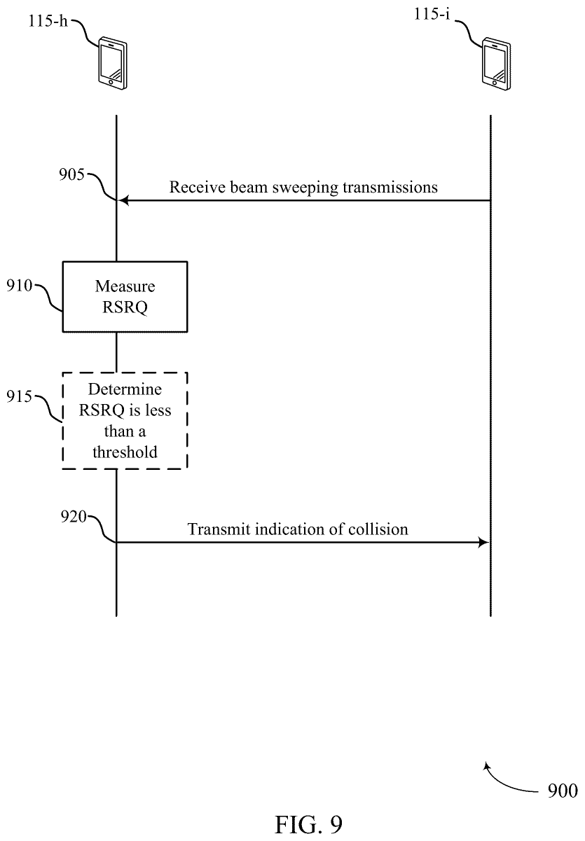

FIG. 9 shows an example of a process flow 900 that supports best beam selection and indication or collision detection and indication in accordance with one or more aspects of the present disclosure. The process flow 900 may implement aspects of or may be implemented by aspects of the wireless communications system 100 or the wireless communications system 200. For example, the process flow 900 may include a UE 115-h and a UE 115-i, which may be an example of a UE 115 as described herein. In the following description of the process flow 900, the operations performed by the UE 115-h and the UE 115-i may be performed in different orders or at different times than the exemplary order shown. Some operations may also be omitted from the process flow 900, or other operations may be added to the process flow 900. Further, while operations in the process flow 900 are illustrated as being performed by the UE 115-h and the UE 115-i, the examples herein are not to be construed as limiting, as the described features may be associated with any quantity of different devices.

At 905, a first UE 115-h (e.g., a receiving UE) may receive, from a second UE 115-i (e.g., a transmitting UE), one or more beam sweeping transmissions during one or more beam sweeping bursts in a resource allocation based on beam management parameter configuration or activation. At 910, the first UE 115-h may measure an RSRQ or SINR of the beam sweeping burst based on receiving the beam sweeping transmissions of the one or more beam sweeping bursts. In some examples, at 915, the first UE 115-h may determine that the RSRQ or SINR of the one or more beam sweeping bursts is less than the threshold that is indicative of the collision, where transmitting the indication is based on determining that the RSRQ or SINR is less than the threshold. In some examples, to determine the RSRQ or SINR, the first UE 115-h may measure an RSRP of a descrambled beam signal of each of beam sweeping transmissions of the one or more beam sweeping bursts. The receiving UE 115-h may measure an RSSI of each of the beam sweeping transmissions of the one or more beam sweeping bursts. Measuring the RSRQ or SINR of each of the beam sweeping transmissions of the one or more beam sweeping bursts is based on the RSRP and the RSSI. In some examples, to measure the RSRP, the first UE 115-h may determine a scrambling sequence associated with a scrambling ID which may be based on service type ID, an application ID, a UE ID associated with the second UE, or any combination thereof. The first UE 115-h may perform a descrambling of each of the beam sweeping transmissions of the one or more beam sweeping bursts based on the scrambling sequence. In some examples, the service type ID, the application ID, the UE ID, or any combination thereof, is related to the resource allocation associated with the reception of the one or more beam sweeping transmissions during the beam sweeping burst.

At 920, the first UE 115-h may transmit, to the second UE 115-i, an indication of a collision between different beam sweeping transmissions from different transmitting UEs (e.g., selecting the same resource for one or more beam sweeping bursts) during the one or more beam sweeping bursts beam sweeping burst based at least in part on the RSRQ or SINR satisfying a threshold. In some examples, the indication may be a single bit sequence representing NACK associated with the one or more beam sweeping bursts.

In some examples, the first UE 115-h may determine that the RSRQ or SINR or RSRP of a beam sweeping transmission of the beam sweeping transmissions of the one or more beam sweeping bursts is greater than a second threshold or a greatest RSRQ or SINR or RSRP value that is indicative of a best transmission beam of the beam sweeping transmissions of the one or more beam sweeping bursts from the second UE. The first UE 115-h may transmit, to the second UE 115-i, an indication of the best transmission beam. In some examples, the indication may include a single bit sequence representing an ACK for best beam indication associated with the one or more beam sweeping bursts. The first UE 115-h may determine a beam response occasion associated with the selected transmission beam. The first UE 115-h may transmit the indication of the best transmission beam or collision at the beam response occasion using a transmission beam corresponding to a reception beam of the first UE that selected the selected transmission beam associated with the second UE.

In some examples, the first UE 115-h may transmit the indication of the best transmission beam or the collision at a beam response occasion associated with an active transmission beam of the second UE using a transmission beam corresponding to a reception beam that is paired with the active transmission beam. In such examples, the first UE 115-h may identify that a PRB of the beam response occasion is mapped to an ID associated with the second UE. The first UE 115-h may transmit the indication of the best beam or collision at the PRB of the beam response occasion. In some examples, the ID may be based on a UE ID, a service type ID, an application ID, or any combination thereof.

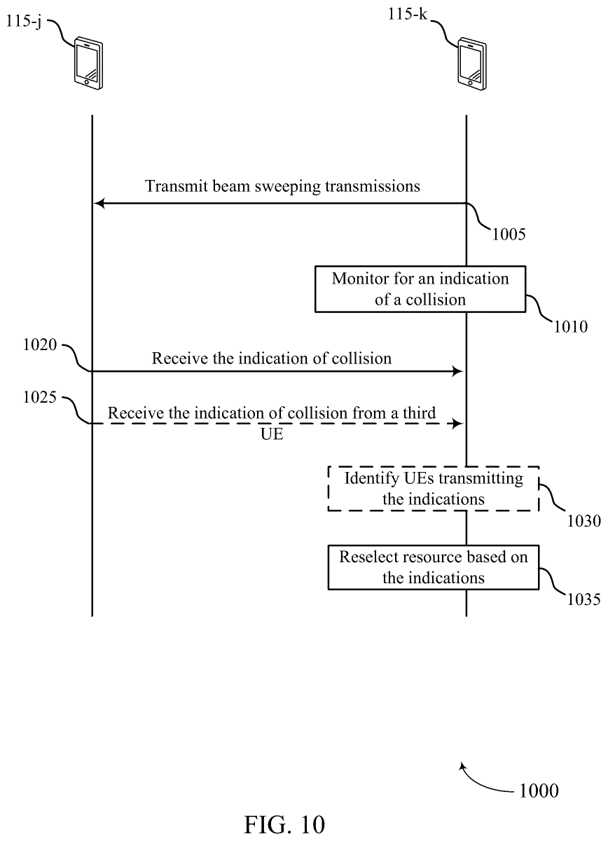

FIG. 10 shows an example of a process flow 1000 that supports best beam selection and collision detection in accordance with one or more aspects of the present disclosure. The process flow 1000 may implement aspects of or may be implemented by aspects of the wireless communications system 100 or the wireless communications system 200. For example, the process flow 1000 may include a UE 115-j and a UE 115-k, which may be an example of a UE 115 as described herein. In the following description of the process flow 1000, the operations performed by the UE 115-j and the UE 115-k may be performed in different orders or at different times than the exemplary order shown. Some operations may also be omitted from the process flow 1000, or other operations may be added to the process flow 1000. Further, while operations in the process flow 1000 are illustrated as being performed by the UE 115-j and the UE 115-k, the examples herein are not to be construed as limiting, as the described features may be associated with any quantity of different devices.

At 1005, a first UE 115-k (e.g., transmitting UE) may transmit, to a second UE 115-j (e.g., receiving UE), beam sweeping transmissions within one or more beam sweeping bursts in a resource selected based on the beam management parameter configuration or activation. In some examples, the first UE 115-k may transmit the beam sweeping transmissions of the one or more beam sweeping bursts using an ID that is indicative of a transmitting UE or a sidelink service. In some examples, the transmitting the beam sweeping transmissions of the one or more beam sweeping bursts is based on a capability message, a sidelink UE information message, a sidelink UE assistance information message, or a combination thereof.

At 1010, the first UE 115-k may monitor for an indication of a best beam or a collision. At 1020, the first UE 115-k may receive the indication of the best beam or collision over a reception beam corresponding to a selected transmission beam associated with the one or more beam sweeping bursts. In some examples, the first UE 115-k may receive the indication of the best beam or collision using a reception beam that is known based on an active beam response occasion associated with the first UE 115-k and the second UE 115-j, where the reception beam corresponds to an active transmission beam. In some examples, at 1025, the first UE 115-k may receive the indication of the best beam or collision over the reception beam from a third UE. In some examples, at 1030, the first UE 115-k may identify the UEs 115 transmitting the indications, such as the indication of the best beam or collision to be from the second UE and from the third UE based on respective services associated with the second UE and the third UE.

At 1035, the first UE 115-k may reselect the resource based on the indication of the collision. In some examples, the first UE 115-k may receive the indication of the collision from the second UE 115-j and a third UE using the reception beam of the transmitting UE 115-k. The first UE 115-k may identify the indication of the collision from the second UE 115-j and the indication of the collision from the third UE based on a second ID and a third ID. The second ID and the third ID nay be indicative of respective UEs, respective sidelink services, respective sidelink applications, or any combination thereof. The first UE 115-k may reselect the resource for transmitting the beam sweeping transmissions of the one or more beam sweeping bursts based on the indication of the collision, the second ID, and the third ID. In some examples, the resource is associated with a sidelink service, a sidelink application, or a combination thereof, associated with the first UE 115-k. In some examples, the resource may include a frequency resource, a time resource, or both.

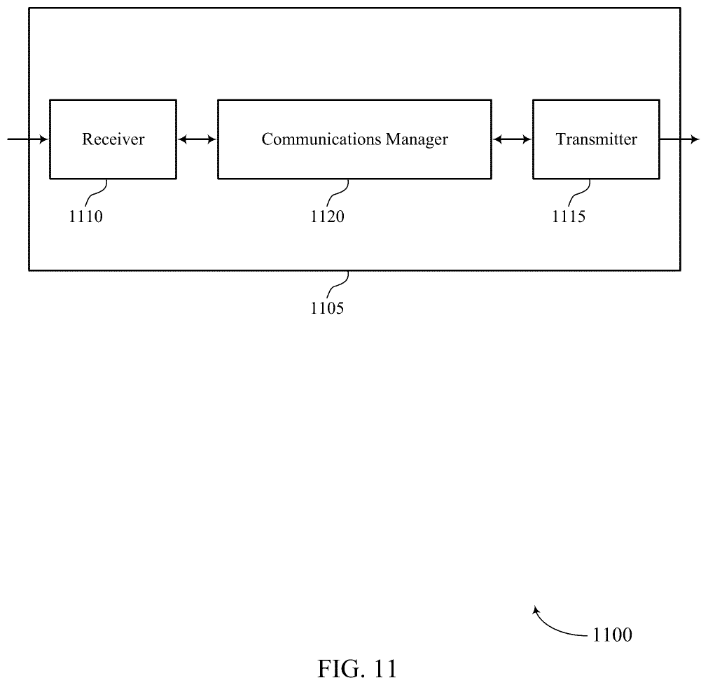

FIG. 11 shows a block diagram 1100 of a device 1105 that supports collision detection in accordance with one or more aspects of the present disclosure. The device 1105 may be an example of aspects of a UE 115 as described herein. The device 1105 may include a receiver 1110, a transmitter 1115, and a communications manager 1120. The device 1105, or one or more components of the device 1105 (e.g., the receiver 1110, the transmitter 1115, and the communications manager 1120), may include at least one processor, which may be coupled with at least one memory, to, individually or collectively, support or enable the described techniques. Each of these components may be in communication with one another (e.g., via one or more buses).

The receiver 1110 may provide a means for receiving information such as packets, user data, control information, or any combination thereof associated with various information channels (e.g., control channels, data channels, information channels related to collision detection). Information may be passed on to other components of the device 1105. The receiver 1110 may utilize a single antenna or a set of multiple antennas.

The transmitter 1115 may provide a means for transmitting signals generated by other components of the device 1105. For example, the transmitter 1115 may transmit information such as packets, user data, control information, or any combination thereof associated with various information channels (e.g., control channels, data channels, information channels related to collision detection). In some examples, the transmitter 1115 may be co-located with a receiver 1110 in a transceiver module. The transmitter 1115 may utilize a single antenna or a set of multiple antennas.

The communications manager 1120, the receiver 1110, the transmitter 1115, or various combinations thereof or various components thereof may be examples of means for performing various aspects of collision detection as described herein. For example, the communications manager 1120, the receiver 1110, the transmitter 1115, or various combinations or components thereof may be capable of performing one or more of the functions described herein.

In some examples, the communications manager 1120, the receiver 1110, the transmitter 1115, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1120, the receiver 1110, the transmitter 1115, or various combinations or components thereof may be implemented in code (e.g., as communications management software or firmware) executed by at least one processor. If implemented in code executed by at least one processor, the functions of the communications manager 1120, the receiver 1110, the transmitter 1115, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1120 may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications in accordance with examples as disclosed herein. For example, the communications manager 1120 is capable of, configured to, or operable to support a means for receiving, from a second UE, one or more beam sweeping transmissions during a beam sweeping burst in a resource allocation. The communications manager 1120 is capable of, configured to, or operable to support a means for measuring a reference signal received quality (RSRQ) of the beam sweeping burst based on receiving the one or more beam sweeping transmissions. The communications manager 1120 is capable of, configured to, or operable to support a means for transmitting, to the second UE, an indication of a collision between different beam sweeping transmissions during the beam sweeping burst based on the RSRQ satisfying a threshold.

Additionally, or alternatively, the communications manager 1120 may support wireless communications in accordance with examples as disclosed herein. For example, the communications manager 1120 is capable of, configured to, or operable to support a means for transmitting, to a second UE, one or more beam sweeping transmissions as a beam sweeping burst in a resource. The communications manager 1120 is capable of, configured to, or operable to support a means for monitoring for an indication of a collision. The communications manager 1120 is capable of, configured to, or operable to support a means for receiving the indication of the collision over a reception beam corresponding to a transmission beam associated with the beam sweeping burst. The communications manager 1120 is capable of, configured to, or operable to support a means for reselecting the resource based on the indication of the collision.

By including or configuring the communications manager 1120 in accordance with examples as described herein, the device 1105 (e.g., at least one processor controlling or otherwise coupled with the receiver 1110, the transmitter 1115, the communications manager 1120, or a combination thereof) may support techniques for reducing degradation and delay otherwise associated with initial beam pairing or beam management when a beam sweeping collision occurs.

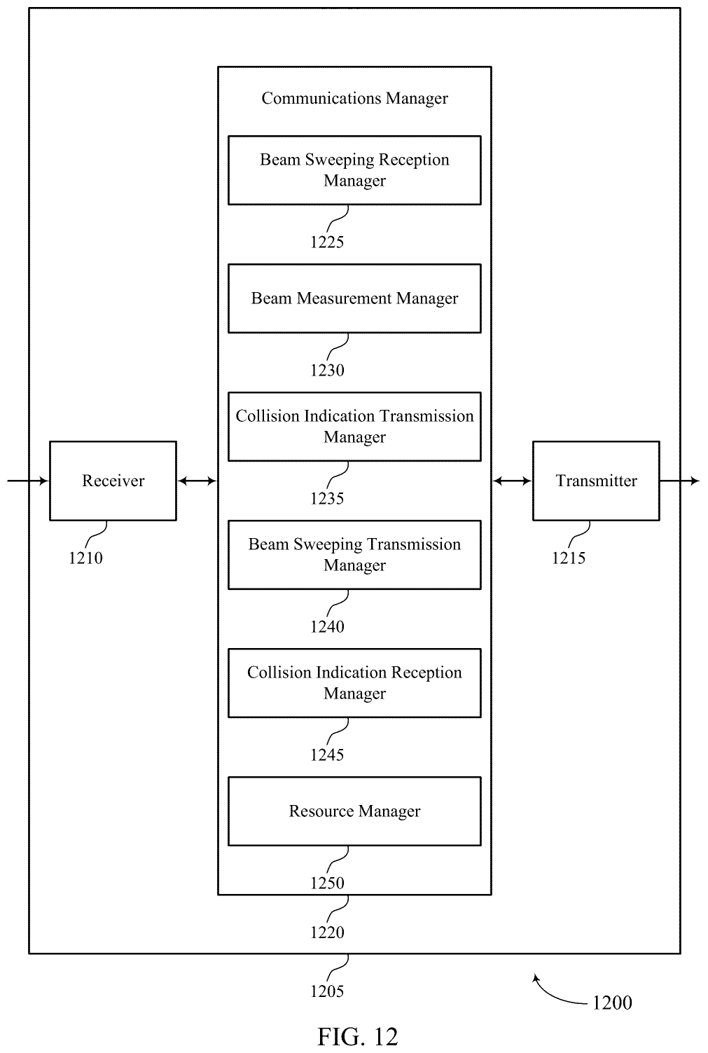

FIG. 12 shows a block diagram 1200 of a device 1205 that supports collision detection in accordance with one or more aspects of the present disclosure. The device 1205 may be an example of aspects of a device 1105 or a UE 115 as described herein. The device 1205 may include a receiver 1210, a transmitter 1215, and a communications manager 1220. The device 1205, or one or more components of the device 1205 (e.g., the receiver 1210, the transmitter 1215, and the communications manager 1220), may include at least one processor, which may be coupled with at least one memory, to support the described techniques. Each of these components may be in communication with one another (e.g., via one or more buses).

The receiver 1210 may provide a means for receiving information such as packets, user data, control information, or any combination thereof associated with various information channels (e.g., control channels, data channels, information channels related to collision detection). Information may be passed on to other components of the device 1205. The receiver 1210 may utilize a single antenna or a set of multiple antennas.

The transmitter 1215 may provide a means for transmitting signals generated by other components of the device 1205. For example, the transmitter 1215 may transmit information such as packets, user data, control information, or any combination thereof associated with various information channels (e.g., control channels, data channels, information channels related to collision detection). In some examples, the transmitter 1215 may be co-located with a receiver 1210 in a transceiver module. The transmitter 1215 may utilize a single antenna or a set of multiple antennas.

The device 1205, or various components thereof, may be an example of means for performing various aspects of collision detection as described herein. For example, the communications manager 1220 may include a beam sweeping reception manager 1225, a beam measurement manager 1230, a collision indication transmission manager 1235, a beam sweeping transmission manager 1240, a collision indication reception manager 1245, a resource manager 1250, or any combination thereof. The communications manager 1220 may be an example of aspects of a communications manager 1120 as described herein. In some examples, the communications manager 1220, or various components thereof, may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communications in accordance with examples as disclosed herein. The beam sweeping reception manager 1225 is capable of, configured to, or operable to support a means for receiving, from a second UE, one or more beam sweeping transmissions during a beam sweeping burst in a resource allocation. The beam measurement manager 1230 is capable of, configured to, or operable to support a means for measuring a reference signal received quality (RSRQ) of the beam sweeping burst based on receiving the one or more beam sweeping transmissions. The collision indication transmission manager 1235 is capable of, configured to, or operable to support a means for transmitting, to the second UE, an indication of a collision between different beam sweeping transmissions during the beam sweeping burst based on the RSRQ satisfying a threshold.

Additionally, or alternatively, the communications manager 1220 may support wireless communications in accordance with examples as disclosed herein. The beam sweeping transmission manager 1240 is capable of, configured to, or operable to support a means for transmitting, to a second UE, one or more beam sweeping transmissions as a beam sweeping burst in a resource. The collision indication reception manager 1245 is capable of, configured to, or operable to support a means for monitoring for an indication of a collision. The collision indication reception manager 1245 is capable of, configured to, or operable to support a means for receiving the indication of the collision over a reception beam corresponding to a transmission beam associated with the beam sweeping burst. The resource manager 1250 is capable of, configured to, or operable to support a means for reselecting the resource based on the indication of the collision.

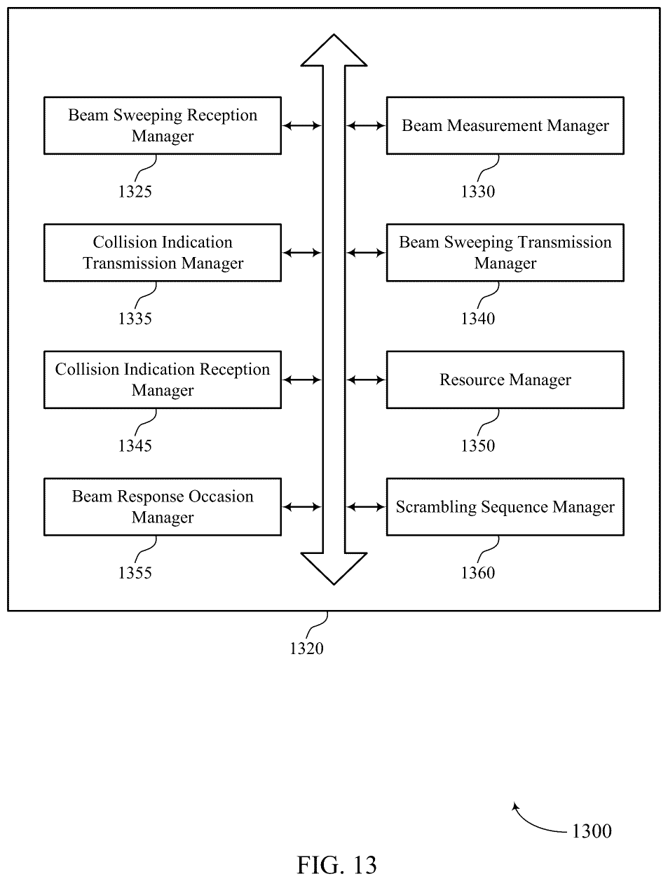

FIG. 13 shows a block diagram 1300 of a communications manager 1320 that supports collision detection in accordance with one or more aspects of the present disclosure. The communications manager 1320 may be an example of aspects of a communications manager 1120, a communications manager 1220, or both, as described herein. The communications manager 1320, or various components thereof, may be an example of means for performing various aspects of collision detection as described herein. For example, the communications manager 1320 may include a beam sweeping reception manager 1325, a beam measurement manager 1330, a collision indication transmission manager 1335, a beam sweeping transmission manager 1340, a collision indication reception manager 1345, a resource manager 1350, a beam response occasion manager 1355, a scrambling sequence manager 1360, or any combination thereof. Each of these components, or components or subcomponents thereof (e.g., one or more processors, one or more memories), may communicate, directly or indirectly, with one another (e.g., via one or more buses).

The communications manager 1320 may support wireless communications in accordance with examples as disclosed herein. The beam sweeping reception manager 1325 is capable of, configured to, or operable to support a means for receiving, from a second UE, one or more beam sweeping transmissions during a beam sweeping burst in a resource allocation. The beam measurement manager 1330 is capable of, configured to, or operable to support a means for measuring a reference signal received quality (RSRQ) of the beam sweeping burst based on receiving the one or more beam sweeping transmissions. The collision indication transmission manager 1335 is capable of, configured to, or operable to support a means for transmitting, to the second UE, an indication of a collision between different beam sweeping transmissions during the beam sweeping burst based on the RSRQ satisfying a threshold.

In some examples, the beam measurement manager 1330 is capable of, configured to, or operable to support a means for determining that the RSRQ of the beam sweeping burst is less than the threshold that is indicative of the collision, where transmitting the indication is based on determining that the RSRQ is less than the threshold.

In some examples, the beam measurement manager 1330 is capable of, configured to, or operable to support a means for determining that the RSRQ of a beam sweeping transmission of the one or more beam sweeping transmissions is greater than a second threshold or a greatest RSRQ value that is indicative of a selected transmission beam associated with the one or more beam sweeping transmissions from the second UE. In some examples, the beam response occasion manager 1355 is capable of, configured to, or operable to support a means for determining a beam response occasion associated with the selected transmission beam. In some examples, the collision indication transmission manager 1335 is capable of, configured to, or operable to support a means for transmitting the indication of the collision at the beam response occasion using a transmission beam corresponding to a reception beam of the first UE that selected the selected transmission beam associated with the second UE.

In some examples, the indication includes a NACK associated with the beam sweeping burst.

In some examples, the beam measurement manager 1330 is capable of, configured to, or operable to support a means for measuring a RSRP of a descrambled beam signal of each of the one or more beam sweeping transmissions. In some examples, the beam measurement manager 1330 is capable of, configured to, or operable to support a means for measuring a RSSI of each of the one or more beam sweeping transmissions, where measuring the RSRQ of each of the one or more beam sweeping transmissions is based on the RSRP and the RSSI.

In some examples, to support measuring the RSRP of the descrambled beam signal of each of the one or more beam sweeping transmissions, the scrambling sequence manager 1360 is capable of, configured to, or operable to support a means for determining a scrambling sequence associated with a service type ID, an application ID, a UE ID associated with the second UE, or any combination thereof. In some examples, to support measuring the RSRP of the descrambled beam signal of each of the one or more beam sweeping transmissions, the scrambling sequence manager 1360 is capable of, configured to, or operable to support a means for performing a descrambling of each of the one or more beam sweeping transmissions based on the scrambling sequence.

In some examples, the service type ID, the application ID, the UE ID, or any combination thereof, is related to the resource allocation associated with the reception of the one or more beam sweeping transmissions during the beam sweeping burst.

In some examples, the indication includes a single bit representing an acknowledgement or a negative acknowledgement associated with the beam sweeping burst.

In some examples, the collision indication transmission manager 1335 is capable of, configured to, or operable to support a means for transmitting the indication of the collision at a beam response occasion associated with an active transmission beam of the second UE using a transmission beam corresponding to a reception beam that is paired with the active transmission beam.

In some examples, the beam response occasion manager 1355 is capable of, configured to, or operable to support a means for identifying that a PRB of the beam response occasion is mapped to an ID associated with the second UE. In some examples, the collision indication transmission manager 1335 is capable of, configured to, or operable to support a means for transmitting the indication of the collision at the PRB of the beam response occasion.

In some examples, the ID is based on a UE ID, a service type ID, an application ID, or any combination thereof.

Additionally, or alternatively, the communications manager 1320 may support wireless communications in accordance with examples as disclosed herein. The beam sweeping transmission manager 1340 is capable of, configured to, or operable to support a means for transmitting, to a second UE, one or more beam sweeping transmissions as a beam sweeping burst in a resource. The collision indication reception manager 1345 is capable of, configured to, or operable to support a means for monitoring for an indication of a collision. In some examples, the collision indication reception manager 1345 is capable of, configured to, or operable to support a means for receiving the indication of the collision over a reception beam corresponding to a transmission beam associated with the beam sweeping burst. The resource manager 1350 is capable of, configured to, or operable to support a means for reselecting the resource based on the indication of the collision.

In some examples, the beam sweeping transmission manager 1340 is capable of, configured to, or operable to support a means for transmitting the one or more beam sweeping transmissions using a UE ID that is indicative of a sidelink service.

In some examples, the collision indication reception manager 1345 is capable of, configured to, or operable to support a means for receiving the indication of the collision using a reception beam that is known based on an active beam response occasion associated with the first UE and the second UE, the reception beam corresponding to a transmission beam of the active beam response occasion.

In some examples, the collision indication reception manager 1345 is capable of, configured to, or operable to support a means for receiving the indication of the collision from the second UE and a third UE using the reception beam. In some examples, the collision indication reception manager 1345 is capable of, configured to, or operable to support a means for identifying the indication of the collision from the second UE and the indication of the collision from the third UE based on a second ID and a third ID, the second ID and the third ID indicative of respective UEs, respective sidelink services, respective sidelink applications, or any combination thereof. In some examples, the resource manager 1350 is capable of, configured to, or operable to support a means for reselecting the resource for transmitting the one or more beam sweeping transmissions based on the indication of the collision, the second ID, and the third ID.

In some examples, the resource is associated with a sidelink service, a sidelink application, or a combination thereof, associated with the first UE.

In some examples, the resource includes a frequency resource, a time resource, or a combination thereof.

In some examples, to support receiving the indication of the collision, the collision indication reception manager 1345 is capable of, configured to, or operable to support a means for receiving the indication of the collision over the reception beam from a third UE. In some examples, to support receiving the indication of the collision, the collision indication reception manager 1345 is capable of, configured to, or operable to support a means for identifying the indication of the collision to be from the second UE and from the third UE based on respective services associated with the second UE and the third UE.

In some examples, transmitting the one or more beam sweeping transmissions is based on a capability message, a sidelink information message, or a combination thereof.

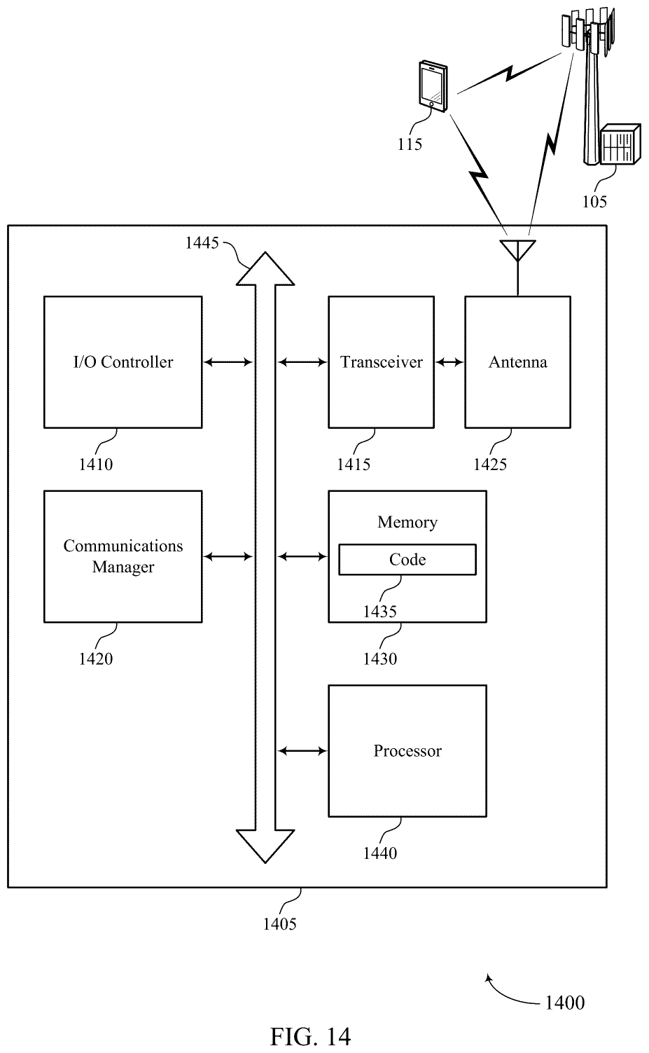

FIG. 14 shows a diagram of a system 1400 including a device 1405 that supports collision detection in accordance with one or more aspects of the present disclosure. The device 1405 may be an example of or include the components of a device 1105, a device 1205, or a UE 115 as described herein. The device 1405 may communicate (e.g., wirelessly) with one or more network entities 105, one or more UEs 115, or any combination thereof. The device 1405 may include components for bi-directional voice and data communications including components for transmitting and receiving communications, such as a communications manager 1420, an input/output (I/O) controller 1410, a transceiver 1415, an antenna 1425, at least one memory 1430, code 1435, and at least one processor 1440. These components may be in electronic communication or otherwise coupled (e.g., operatively, communicatively, functionally, electronically, electrically) via one or more buses (e.g., a bus 1445).

The I/O controller 1410 may manage input and output signals for the device 1405. The I/O controller 1410 may also manage peripherals not integrated into the device 1405. In some cases, the I/O controller 1410 may represent a physical connection or port to an external peripheral. In some cases, the I/O controller 1410 may utilize an operating system such as iOS®, ANDROID®, MS-DOS®, MS-WINDOWS®, OS/2®, UNIX®, LINUX®, or another known operating system. Additionally, or alternatively, the I/O controller 1410 may represent or interact with a modem, a keyboard, a mouse, a touchscreen, or a similar device. In some cases, the I/O controller 1410 may be implemented as part of one or more processors, such as the at least one processor 1440. In some cases, a user may interact with the device 1405 via the I/O controller 1410 or via hardware components controlled by the I/O controller 1410.

In some cases, the device 1405 may include a single antenna 1425. However, in some other cases, the device 1405 may have more than one antenna 1425, which may be capable of concurrently transmitting or receiving multiple wireless transmissions. The transceiver 1415 may communicate bi-directionally, via the one or more antennas 1425, wired, or wireless links as described herein. For example, the transceiver 1415 may represent a wireless transceiver and may communicate bi-directionally with another wireless transceiver. The transceiver 1415 may also include a modem to modulate the packets, to provide the modulated packets to one or more antennas 1425 for transmission, and to demodulate packets received from the one or more antennas 1425. The transceiver 1415, or the transceiver 1415 and one or more antennas 1425, may be an example of a transmitter 1115, a transmitter 1215, a receiver 1110, a receiver 1210, or any combination thereof or component thereof, as described herein.

The at least one memory 1430 may include random access memory (RAM) and read-only memory (ROM). The at least one memory 1430 may store computer-readable, computer-executable code 1435 including instructions that, when executed by the at least one processor 1440, cause the device 1405 to perform various functions described herein. The code 1435 may be stored in a non-transitory computer-readable medium such as system memory or another type of memory. In some cases, the code 1435 may not be directly executable by the at least one processor 1440 but may cause a computer (e.g., when compiled and executed) to perform functions described herein. In some cases, the at least one memory 1430 may contain, among other things, a basic I/O system (BIOS) which may control basic hardware or software operation such as the interaction with peripheral components or devices.

The at least one processor 1440 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the at least one processor 1440 may be configured to operate a memory array using a memory controller. In some other cases, a memory controller may be integrated into the at least one processor 1440. The at least one processor 1440 may be configured to execute computer-readable instructions stored in a memory (e.g., the at least one memory 1430) to cause the device 1405 to perform various functions (e.g., functions or tasks supporting collision detection). For example, the device 1405 or a component of the device 1405 may include at least one processor 1440 and at least one memory 1430 coupled with or to the at least one processor 1440, the at least one processor 1440 and at least one memory 1430 configured to perform various functions described herein. In some examples, the at least one processor 1440 may include multiple processors and the at least one memory 1430 may include multiple memories. One or more of the multiple processors may be coupled with one or more of the multiple memories, which may, individually or collectively, be configured to perform various functions herein.

The communications manager 1420 may support wireless communications in accordance with examples as disclosed herein. For example, the communications manager 1420 is capable of, configured to, or operable to support a means for receiving, from a second UE, one or more beam sweeping transmissions during a beam sweeping burst in a resource allocation. The communications manager 1420 is capable of, configured to, or operable to support a means for measuring a reference signal received quality (RSRQ) of the beam sweeping burst based on receiving the one or more beam sweeping transmissions. The communications manager 1420 is capable of, configured to, or operable to support a means for transmitting, to the second UE, an indication of a collision between different beam sweeping transmissions during the beam sweeping burst based on the RSRQ satisfying a threshold.

Additionally, or alternatively, the communications manager 1420 may support wireless communications in accordance with examples as disclosed herein. For example, the communications manager 1420 is capable of, configured to, or operable to support a means for transmitting, to a second UE, one or more beam sweeping transmissions as a beam sweeping burst in a resource. The communications manager 1420 is capable of, configured to, or operable to support a means for monitoring for an indication of a collision. The communications manager 1420 is capable of, configured to, or operable to support a means for receiving the indication of the collision over a reception beam corresponding to a transmission beam associated with the beam sweeping burst. The communications manager 1420 is capable of, configured to, or operable to support a means for reselecting the resource based on the indication of the collision.

By including or configuring the communications manager 1420 in accordance with examples as described herein, the device 1405 may support techniques for reducing degradation and delay otherwise associated with initial beam pairing or beam management when a beam sweeping collision occurs.

In some examples, the communications manager 1420 may be configured to perform various operations (e.g., receiving, monitoring, transmitting) using or otherwise in cooperation with the transceiver 1415, the one or more antennas 1425, or any combination thereof. Although the communications manager 1420 is illustrated as a separate component, in some examples, one or more functions described with reference to the communications manager 1420 may be supported by or performed by the at least one processor 1440, the at least one memory 1430, the code 1435, or any combination thereof. For example, the code 1435 may include instructions executable by the at least one processor 1440 to cause the device 1405 to perform various aspects of collision detection as described herein, or the at least one processor 1440 and the at least one memory 1430 may be otherwise configured to, individually or collectively, perform or support such operations.

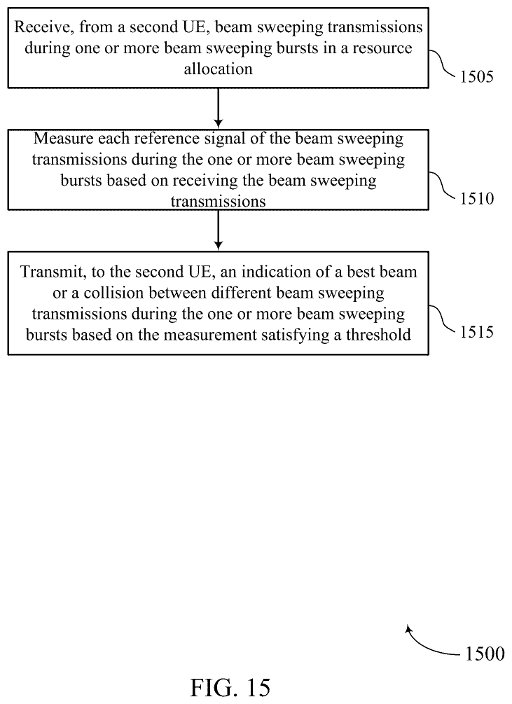

FIG. 15 shows a flowchart illustrating a method 1500 that supports collision detection in accordance with aspects of the present disclosure. The operations of the method 1500 may be implemented by a UE or its components as described herein. For example, the operations of the method 1500 may be performed by a UE 115 as described with reference to FIGS. 1 through 14. In some examples, a UE may execute a set of instructions to control the functional elements of the UE to perform the described functions. Additionally, or alternatively, the UE may perform aspects of the described functions using special-purpose hardware.

At 1505, the method may include receiving, from a second UE, beam sweeping transmissions during one or more beam sweeping bursts in a resource allocation. The operations of block 1505 may be performed in accordance with examples as disclosed herein. In some examples, aspects of the operations of 1505 may be performed by a beam sweeping reception manager 1325 as described with reference to FIG. 13.

At 1510, the method may include measuring each reference signal of the beam sweeping transmissions during the one or more beam sweeping bursts burst based on receiving the beam sweeping transmissions. The operations of block 1510 may be performed in accordance with examples as disclosed herein. In some examples, aspects of the operations of 1510 may be performed by a beam measurement manager 1330 as described with reference to FIG. 13.

At 1515, the method may include transmitting, to the second UE, an indication of a best beam or a collision between different beam sweeping transmissions during the one or more beam sweeping bursts based on the measurement satisfying a threshold. The operations of block 1515 may be performed in accordance with examples as disclosed herein. In some examples, aspects of the operations of 1515 may be performed by a collision indication transmission manager 1335 as described with reference to FIG. 13.

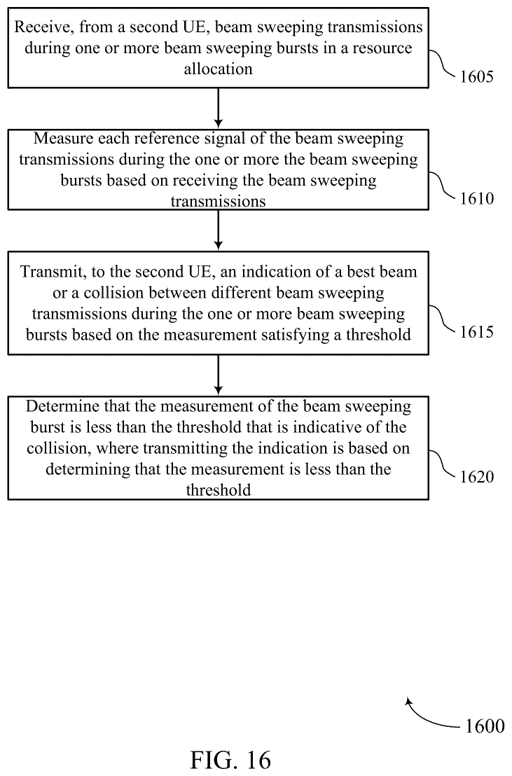

FIG. 16 shows a flowchart illustrating a method 1600 that supports collision detection in accordance with aspects of the present disclosure. The operations of the method 1600 may be implemented by a UE or its components as described herein. For example, the operations of the method 1600 may be performed by a UE 115 as described with reference to FIGS. 1 through 14. In some examples, a UE may execute a set of instructions to control the functional elements of the UE to perform the described functions. Additionally, or alternatively, the UE may perform aspects of the described functions using special-purpose hardware.

At 1605, the method may include receiving, from a second UE, beam sweeping transmissions during one or more beam sweeping bursts in a resource allocation. The operations of block 1605 may be performed in accordance with examples as disclosed herein. In some examples, aspects of the operations of 1605 may be performed by a beam sweeping reception manager 1325 as described with reference to FIG. 13.

At 1610, the method may include measuring each reference signal of the beam sweeping transmissions during the one or more beam sweeping bursts based on receiving the beam sweeping transmissions. The operations of block 1610 may be performed in accordance with examples as disclosed herein. In some examples, aspects of the operations of 1610 may be performed by a beam measurement manager 1330 as described with reference to FIG. 13.

At 1615, the method may include transmitting, to the second UE, an indication of a best beam or a collision between different beam sweeping transmissions during the one or more beam sweeping bursts based on the measurement satisfying a threshold. The operations of block 1615 may be performed in accordance with examples as disclosed herein. In some examples, aspects of the operations of 1615 may be performed by a collision indication transmission manager 1335 as described with reference to FIG. 13.

At 1620, the method may include determining that the measurement of the beam sweeping burst is less than the threshold that is indicative of the collision, where transmitting the indication is based on determining that the measurement is less than the threshold. The operations of block 1620 may be performed in accordance with examples as disclosed herein. In some examples, aspects of the operations of 1620 may be performed by a beam measurement manager 1330 as described with reference to FIG. 13.

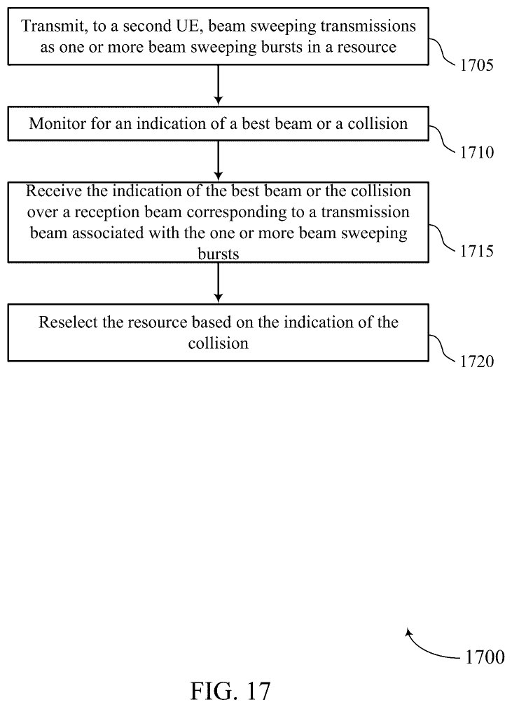

FIG. 17 shows a flowchart illustrating a method 1700 that supports collision detection in accordance with aspects of the present disclosure. The operations of the method 1700 may be implemented by a UE or its components as described herein. For example, the operations of the method 1700 may be performed by a UE 115 as described with reference to FIGS. 1 through 14. In some examples, a UE may execute a set of instructions to control the functional elements of the UE to perform the described functions. Additionally, or alternatively, the UE may perform aspects of the described functions using special-purpose hardware.

At 1705, the method may include transmitting, to a second UE, beam sweeping transmissions as one or more beam sweeping bursts in a resource. The operations of block 1705 may be performed in accordance with examples as disclosed herein. In some examples, aspects of the operations of 1705 may be performed by a beam sweeping transmission manager 1340 as described with reference to FIG. 13.

At 1710, the method may include monitoring for an indication of a best beam or a collision. The operations of block 1710 may be performed in accordance with examples as disclosed herein. In some examples, aspects of the operations of 1710 may be performed by a collision indication reception manager 1345 as described with reference to FIG. 13.

At 1715, the method may include receiving the indication of the best beam or the collision over a reception beam corresponding to a transmission beam associated with the one or more beam sweeping bursts. The operations of block 1715 may be performed in accordance with examples as disclosed herein. In some examples, aspects of the operations of 1715 may be performed by a collision indication reception manager 1345 as described with reference to FIG. 13.

At 1720, the method may include reselecting the resource based on the indication of the collision. The operations of block 1720 may be performed in accordance with examples as disclosed herein. In some examples, aspects of the operations of 1720 may be performed by a resource manager 1350 as described with reference to FIG. 13.

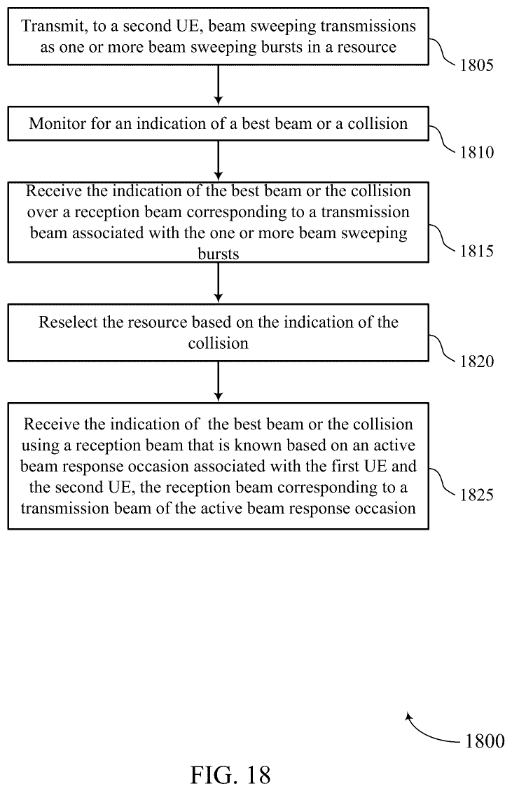

FIG. 18 shows a flowchart illustrating a method 1800 that supports collision detection in accordance with aspects of the present disclosure. The operations of the method 1800 may be implemented by a UE or its components as described herein. For example, the operations of the method 1800 may be performed by a UE 115 as described with reference to FIGS. 1 through 14. In some examples, a UE may execute a set of instructions to control the functional elements of the UE to perform the described functions. Additionally, or alternatively, the UE may perform aspects of the described functions using special-purpose hardware.

At 1805, the method may include transmitting, to a second UE, beam sweeping transmissions as one or more beam sweeping bursts in a resource. The operations of block 1805 may be performed in accordance with examples as disclosed herein. In some examples, aspects of the operations of 1805 may be performed by a beam sweeping transmission manager 1340 as described with reference to FIG. 13.

At 1810, the method may include monitoring for an indication of a best beam or a collision. The operations of block 1810 may be performed in accordance with examples as disclosed herein. In some examples, aspects of the operations of 1810 may be performed by a collision indication reception manager 1345 as described with reference to FIG. 13.

At 1815, the method may include receiving the indication of the best beam or the collision over a reception beam corresponding to a transmission beam associated with one or more beam sweeping bursts. The operations of block 1815 may be performed in accordance with examples as disclosed herein. In some examples, aspects of the operations of 1815 may be performed by a collision indication reception manager 1345 as described with reference to FIG. 13.

At 1820, the method may include reselecting the resource based on the indication of the collision. The operations of block 1820 may be performed in accordance with examples as disclosed herein. In some examples, aspects of the operations of 1820 may be performed by a resource manager 1350 as described with reference to FIG. 13.

At 1825, the method may include receiving the indication of the best beam or the collision using a reception beam that is known based on an active beam response occasion associated with the first UE and the second UE, the reception beam corresponding to a transmission beam of the active beam response occasion. The operations of block 1825 may be performed in accordance with examples as disclosed herein. In some examples, aspects of the operations of 1825 may be performed by a collision indication reception manager 1345 as described with reference to FIG. 13.

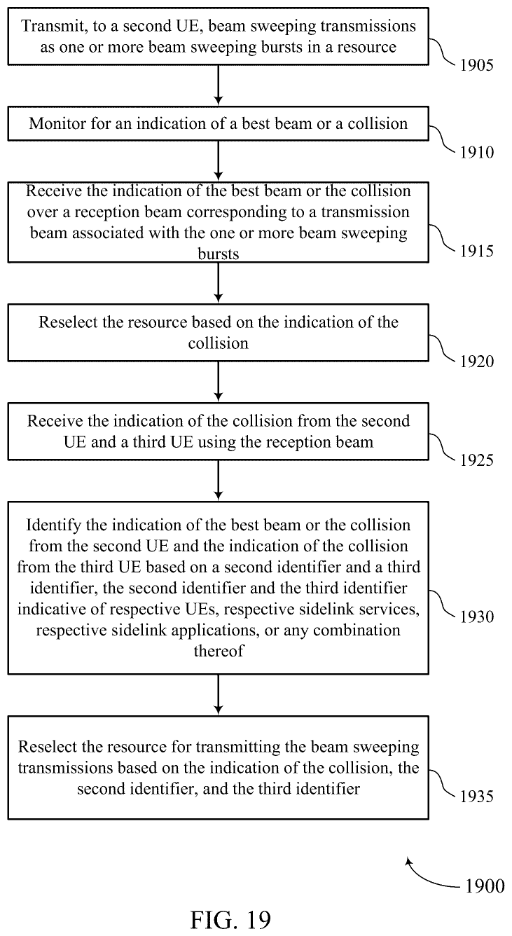

FIG. 19 shows a flowchart illustrating a method 1900 that supports collision detection in accordance with aspects of the present disclosure. The operations of the method 1900 may be implemented by a UE or its components as described herein. For example, the operations of the method 1900 may be performed by a UE 115 as described with reference to FIGS. 1 through 14. In some examples, a UE may execute a set of instructions to control the functional elements of the UE to perform the described functions. Additionally, or alternatively, the UE may perform aspects of the described functions using special-purpose hardware.

At 1905, the method may include transmitting, to a second UE, beam sweeping transmissions as one or more beam sweeping bursts in a resource. The operations of block 1905 may be performed in accordance with examples as disclosed herein. In some examples, aspects of the operations of 1905 may be performed by a beam sweeping transmission manager 1340 as described with reference to FIG. 13.

At 1910, the method may include monitoring for an indication of a best beam or a collision. The operations of block 1910 may be performed in accordance with examples as disclosed herein. In some examples, aspects of the operations of 1910 may be performed by a collision indication reception manager 1345 as described with reference to FIG. 13.

At 1915, the method may include receiving the indication of the best beam or the collision over a reception beam corresponding to a transmission beam associated with the one or more beam sweeping bursts. The operations of block 1915 may be performed in accordance with examples as disclosed herein. In some examples, aspects of the operations of 1915 may be performed by a collision indication reception manager 1345 as described with reference to FIG. 13.

At 1920, the method may include reselecting the resource based on the indication of the collision. The operations of block 1920 may be performed in accordance with examples as disclosed herein. In some examples, aspects of the operations of 1920 may be performed by a resource manager 1350 as described with reference to FIG. 13.

At 1925, the method may include receiving the indication of the collision from the second UE and a third UE using the reception beam. The operations of block 1925 may be performed in accordance with examples as disclosed herein. In some examples, aspects of the operations of 1925 may be performed by a collision indication reception manager 1345 as described with reference to FIG. 13.

At 1930, the method may include identifying the indication of the best beam or the collision from the second UE and the indication of the collision from the third UE based on a second ID and a third ID, the second ID and the third ID indicative of respective UEs, respective sidelink services, respective sidelink applications, or any combination thereof. The operations of block 1930 may be performed in accordance with examples as disclosed herein. In some examples, aspects of the operations of 1930 may be performed by a collision indication reception manager 1345 as described with reference to FIG. 13.

At 1935, the method may include reselecting the resource for transmitting the beam sweeping transmissions based on the indication of the collision, the second ID, and the third ID. The operations of block 1935 may be performed in accordance with examples as disclosed herein. In some examples, aspects of the operations of 1935 may be performed by a resource manager 1350 as described with reference to FIG. 13.

The following provides an overview of aspects of the present disclosure:

Aspect 1: A method for wireless communications at a UE, comprising: receiving, from a second UE, one or more beam sweeping transmissions during a beam sweeping burst in a resource allocation, measuring each reference signal of the beam sweeping burst based at least in part on receiving the one or more beam sweeping transmissions, and transmitting, to the second UE, an indication of a collision between different beam sweeping transmissions during the beam sweeping burst based at least in part on the measurement satisfying a threshold.

Aspect 2: The method of aspect 1, further comprising: determining that the measurement of the beam sweeping burst is less than the threshold that is indicative of the collision, wherein transmitting the indication is based at least in part on determining that the measurement is less than the threshold.

Aspect 3: The method of any of aspects 1 through 2, further comprising: determining that the measurement of a beam sweeping transmission of the one or more beam sweeping transmissions is greater than a second threshold or a greatest measurement value that is indicative of a selected transmission beam associated with the one or more beam sweeping transmissions from the second UE, determining a beam response occasion associated with the selected transmission beam, and transmitting the indication of the collision at the beam response occasion using a transmission beam corresponding to a reception beam of the first UE that selected the selected transmission beam associated with the second UE.

Aspect 4: The method of any of aspects 1 through 3, wherein the indication comprises a NACK associated with the beam sweeping burst.

Aspect 5: The method of any of aspects 1 through 4, further comprising: measuring a RSRP of a descrambled beam signal of each of the one or more beam sweeping transmissions, and measuring a RSSI of each of the one or more beam sweeping transmissions, wherein measuring the measurement of each of the one or more beam sweeping transmissions is based at least in part on the RSRP and the RSSI.

Aspect 6: The method of any of aspects 1 through 5, wherein measuring the RSRP of the descrambled beam signal of each of the one or more beam sweeping transmissions, the one or more processors further comprises determining a scrambling sequence associated with a service type identifier, an application identifier, a UE identifier associated with the second UE, or any combination thereof, and performing a descrambling of each of the one or more beam sweeping transmissions based at least in part on the scrambling sequence.

Aspect 7: The method of any of aspects 1 through 6, wherein the service type identifier, the application identifier, the UE identifier, or any combination thereof, is related to the resource allocation associated with reception of the one or more beam sweeping transmissions during the beam sweeping burst.

Aspect 8: The method of any of aspects 1 through 8, wherein the indication comprises a single bit representing an acknowledgement or a negative acknowledgement associated with the beam sweeping burst.

Aspect 9: The method of any of aspects 1 through 9, further comprising: transmitting the indication of the collision at a beam response occasion associated with an active transmission beam of the second UE using a transmission beam corresponding to a reception beam that is paired with the active transmission beam.

Aspect 10: The method of any of any of aspects 1 through 10, further comprising: identifying that a PRB of the beam response occasion is mapped to an identifier associated with the second UE, and transmitting the indication of the collision at the PRB of the beam response occasion.

Aspect 11: The method of any of aspects 1 through 11, wherein the identifier is based at least in part on a UE identifier, a service type identifier, an application identifier, or any combination thereof.

Aspect 12. A method for wireless communications at a UE, comprising: transmitting, to a second UE, one or more beam sweeping transmissions as a beam sweeping burst in a resource, monitoring for an indication of a collision, receiving the indication of the collision over a reception beam corresponding to a transmission beam associated with the beam sweeping burst; and reselecting the resource based at least in part on the indication of the collision.

Aspect 13: The method of aspect 12, further comprising: transmitting the one or more beam sweeping transmissions using a UE identifier that is indicative of a sidelink service.

Aspect 14: The method of any of aspects 12 through 13, further comprising: receiving the indication of the collision using a reception beam that is known based at least in part on an active beam response occasion associated with the first UE and the second UE, the reception beam corresponding to a transmission beam of the active beam response occasion.

Aspect 15: The method of any of aspects 12 through 14, further comprising: receiving the indication of the collision from the second UE and a third UE using the reception beam, identifying the indication of the collision from the second UE and the indication of the collision from the third UE based at least in part on a second identifier and a third identifier, the second identifier and the third identifier indicative of respective UEs, respective sidelink services, respective sidelink applications, or any combination thereof, and reselecting the resource for transmitting the one or more beam sweeping transmissions based at least in part on the indication of the collision, the second identifier, and the third identifier.

Aspect 16: The method of any of aspects 12 through 15, wherein the resource is associated with a sidelink service, a sidelink application, or a combination thereof, associated with the first UE.

Aspect 17: The method of any of aspects 12 through 16, wherein the resource comprises a frequency resource, a time resource, or a combination thereof.

Aspect 18: The method of any of aspects 12 through 17, further comprising: receiving the indication of the collision over the reception beam from a third UE, and identifying the indication of the collision to be from the second UE and from the third UE based at least in part on respective services associated with the second UE and the third UE.

Aspect 19: The method of any of aspects 12 through 18, wherein transmitting the one or more beam sweeping transmissions is based at least in part on a capability message, a sidelink information message, or a combination thereof.

Aspect 20: A first UE for wireless communications, comprising one or more memories storing processor-executable code, and one or more processors coupled with the one or more memories and individually or collectively operable to execute the code to cause the UE to perform a method of any of aspects 1 through 11.

Aspect 21: A first UE for wireless communications, comprising at least one means for performing a method of any of aspects 1 through 11.

Aspect 22: A non-transitory computer-readable medium storing code for wireless communications, the code comprising instructions executable by a processor to perform a method of any of aspects 1 through 11.

Aspect 23: A first UE for wireless communications, comprising one or more memories storing processor-executable code, and one or more processors coupled with the one or more memories and individually or collectively operable to execute the code to cause the network entity to perform a method of any of aspects 12 through 19.

Aspect 24: A first UE for wireless communications, comprising at least one means for performing a method of any of aspects 12 through 19.

Aspect 25: A non-transitory computer-readable medium storing code for wireless communications, the code comprising instructions executable by a processor to perform a method of any of aspects 12 through 19.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A first user equipment (UE), comprising:
one or more memories storing processor-executable code; and
one or more processors coupled with the one or more memories and individually or collectively operable to execute the code to cause the first UE to:
receive, from a second UE, one or more beam sweeping transmissions during a beam sweeping burst in a resource allocation;
measure each reference signal of the beam sweeping burst based at least in part on receiving the one or more beam sweeping transmissions; and
transmit, to the second UE, an indication of a collision between different beam sweeping transmissions during the beam sweeping burst based at least in part on the measurement satisfying a threshold.

2. The first UE of claim 1, wherein the one or more processors are individually or collectively further operable to execute the code to cause the first UE to:
determine that the measurement of the beam sweeping burst is less than the threshold that is indicative of the collision, wherein transmitting the indication is based at least in part on determining that the measurement is less than the threshold.

3. The first UE of claim 1, wherein the one or more processors are individually or collectively further operable to execute the code to cause the first UE to:
determine that the measurement of a beam sweeping transmission of the one or more beam sweeping transmissions is greater than a second threshold or a greatest measurement value that is indicative of a selected transmission beam associated with the one or more beam sweeping transmissions from the second UE;
determine a beam response occasion associated with the selected transmission beam, and
transmit the indication of the collision at the beam response occasion using a transmission beam corresponding to a reception beam of the first UE that selected the selected transmission beam associated with the second UE.

4. The first UE of claim 1, wherein the indication comprises a negative-acknowledgement (NACK) associated with the beam sweeping burst.

5. The first UE of claim 1, wherein the one or more processors are individually or collectively further operable to execute the code to cause the first UE to:
measure a reference signal received power (RSRP) of a descrambled beam signal of each of the one or more beam sweeping transmissions; and
measure a received signal strength indicator (RSSI) of each of the one or more beam sweeping transmissions, wherein measuring the measurement of each of the one or more beam sweeping transmissions is based at least in part on the RSRP and the RSSI.

6. The first UE of claim 5, wherein, to measure the RSRP of the descrambled beam signal of each of the one or more beam sweeping transmissions, the one or more processors are individually or collectively further operable to execute the code to cause the first UE to:
determine a scrambling sequence associated with a service type identifier, an application identifier, a UE identifier associated with the second UE, or any combination thereof; and
perform a descrambling of each of the one or more beam sweeping transmissions based at least in part on the scrambling sequence.

7. The first UE of claim 6, wherein the service type identifier, the application identifier, the UE identifier, or any combination thereof, is related to the resource allocation associated with reception of the one or more beam sweeping transmissions during the beam sweeping burst.

8. The first UE of claim 1, wherein the indication comprises a single bit representing an acknowledgement or a negative acknowledgement associated with the beam sweeping burst.

9. The first UE of claim 1, wherein the one or more processors are individually or collectively further operable to execute the code to cause the first UE to:
transmit the indication of the collision at a beam response occasion associated with an active transmission beam of the second UE using a transmission beam corresponding to a reception beam that is paired with the active transmission beam.

10. The first UE of claim 9, wherein the one or more processors are individually or collectively further operable to execute the code to cause the first UE to:
identify that a physical resource block (PRB) of the beam response occasion is mapped to an identifier associated with the second UE, and
transmit the indication of the collision at the PRB of the beam response occasion.

11. The first UE of claim 10, wherein the identifier is based at least in part on a UE identifier, a service type identifier, an application identifier, or any combination thereof.

12. A first user equipment (UE), comprising:
one or more memories storing processor-executable code; and
one or more processors coupled with the one or more memories and individually or collectively operable to execute the code to cause the first UE to:
transmit, to a second UE, one or more beam sweeping transmissions as a beam sweeping burst in a resource;
monitor for an indication of a collision;
receive the indication of the collision over a reception beam corresponding to a transmission beam associated with the beam sweeping burst; and
reselect the resource based at least in part on the indication of the collision.

13. The first UE of claim 12, wherein the one or more processors are individually or collectively further operable to execute the code to cause the first UE to:
transmit the one or more beam sweeping transmissions using a UE identifier that is indicative of a sidelink service.

14. The first UE of claim 12, wherein the one or more processors are individually or collectively further operable to execute the code to cause the first UE to:
receive the indication of the collision using a reception beam that is known based at least in part on an active beam response occasion associated with the first UE and the second UE, the reception beam corresponding to a transmission beam of the active beam response occasion.

15. The first UE of claim 14, wherein the one or more processors are individually or collectively further operable to execute the code to cause the first UE to:
receive the indication of the collision from the second UE and a third UE using the reception beam;
identify the indication of the collision from the second UE and the indication of the collision from the third UE based at least in part on a second identifier and a third identifier, the second identifier and the third identifier indicative of respective UEs, respective sidelink services, respective sidelink applications, or any combination thereof; and
reselect the resource for transmitting the one or more beam sweeping transmissions based at least in part on the indication of the collision, the second identifier, and the third identifier.

16. The first UE of claim 12, wherein the resource is associated with a sidelink service, a sidelink application, or a combination thereof, associated with the first UE.

17. The first UE of claim 12, wherein the resource comprises a frequency resource, a time resource, or a combination thereof.

18. The first UE of claim 12, wherein, to receive the indication of the collision, the one or more processors are individually or collectively further operable to execute the code to cause the first UE to:
receive the indication of the collision over the reception beam from a third UE; and
identify the indication of the collision to be from the second UE and from the third UE based at least in part on respective services associated with the second UE and the third UE.

19. The first UE of claim 12, wherein transmitting the one or more beam sweeping transmissions is based at least in part on a capability message, a sidelink information message, or a combination thereof.

20. A method for wireless communications at a first user equipment (UE), comprising:
receiving, from a second UE, one or more beam sweeping transmissions during a beam sweeping burst in a resource allocation;
measuring each reference signal of the beam sweeping burst based at least in part on receiving the one or more beam sweeping transmissions; and
transmitting, to the second UE, an indication of a collision between different beam sweeping transmissions during the beam sweeping burst based at least in part on the measurement satisfying a threshold.

21. The method of claim 20, furthering comprising:
determining that the measurement of the beam sweeping burst is less than the threshold that is indicative of the collision, wherein transmitting the indication is based at least in part on determining that the measurement is less than the threshold.

22. The method of claim 20, further comprising:
determining that the measurement of a beam sweeping transmission of the one or more beam sweeping transmissions is greater than a second threshold or a greatest measurement value that is indicative of a selected transmission beam associated with the one or more beam sweeping transmissions from the second UE;
determining a beam response occasion associated with the selected transmission beam, and
transmitting the indication of the collision at the beam response occasion using a transmission beam corresponding to a reception beam of the first UE that selected the selected transmission beam associated with the second UE.

23. The method of claim 20, wherein the indication comprises a negative-acknowledgement (NACK) associated with the beam sweeping burst.

24. The method of claim 20, further comprising:
measuring a reference signal received power (RSRP) of a descrambled beam signal of each of the one or more beam sweeping transmissions; and
measuring a received signal strength indicator (RSSI) of each of the one or more beam sweeping transmissions, wherein measuring the measurement of each of the one or more beam sweeping transmissions is based at least in part on the RSRP and the RSSI.

25. The method of claim 24, wherein measuring the RSRP of the descrambled beam signal of each of the one or more beam sweeping transmissions further comprises:
determining a scrambling sequence associated with a service type identifier, an application identifier, a UE identifier associated with the second UE, or any combination thereof; and
performing a descrambling of each of the one or more beam sweeping transmissions based at least in part on the scrambling sequence.

26. The method of claim 25, wherein the service type identifier, the application identifier, the UE identifier, or any combination thereof, is related to the resource allocation associated with reception of the one or more beam sweeping transmissions during the beam sweeping burst.

27. A method for wireless communications at a first user equipment (UE), comprising:
transmitting, to a second UE, one or more beam sweeping transmissions as a beam sweeping burst in a resource;
monitoring for an indication of a collision;
receiving the indication of the collision over a reception beam corresponding to a transmission beam associated with the beam sweeping burst; and
reselecting the resource based at least in part on the indication of the collision.

28. The method of claim 27, further comprising:
transmitting the one or more beam sweeping transmissions using a UE identifier that is indicative of a sidelink service.

29. The method of claim 27, further comprising:
receiving the indication of the collision using a reception beam that is known based at least in part on an active beam response occasion associated with the first UE and the second UE, the reception beam corresponding to a transmission beam of the active beam response occasion.

30. The method of claim 29, further comprising:
receiving the indication of the collision from the second UE and a third UE using the reception beam;
identifying the indication of the collision from the second UE and the indication of the collision from the third UE based at least in part on a second identifier and a third identifier, the second identifier and the third identifier indicative of respective UEs, respective sidelink services, respective sidelink applications, or any combination thereof; and
reselecting the resource for transmitting the one or more beam sweeping transmissions based at least in part on the indication of the collision, the second identifier, and the third identifier.
